(19) United States
(12) Patent Application Publication
(10) Pub. No.: US 2009/0136218 A1
(43) Pub. Date: May 28, 2009

(54) Multimedia presentation format

(75) Inventors: Dagan Packman, Longmont, CO (US); Steven Bernard Volk, Boulder, CO (US)

Correspondence Address: PATENTABILITY ASSOCIATES, P.O. BOX 9551, SAN JOSE, CA, 95157, US

(73) Assignee: Vmedia Research, Inc., Boulder, CO (US)

(21) Appl. No.: 12/316,191

(22) Filed: Dec. 10, 2008

Related U.S. Application Data
(63) Continuation-in-part of application No. 11/891,892, filed on Aug. 14, 2007.
(60) Provisional application No. 60/837,530, filed on Aug. 14, 2006.

(51) Int. Cl. H04N 5/00

(52) U.S. Cl. 386/126; 386/E05.001

(57) ABSTRACT

A format for accessing content such as a full-length movie from an optical disc uses an XML Description File stored on the disc to generate one or more screens that a user employs to access the content. To increase the efficiency of accessing data, data files that describe the content of the disc are located near the beginning of the video zone whereas larger data files, such as presentation files, are located at the end of the video zone. To reduce the possibility of incompatibilities between commands, a limited set of application program interface (API) commands is defined for use in an XML Description File. To maximize the vertical data recorded on the disc when the source aspect ratio is high, two, independent horizontal and vertical distortion factors are used. The audio and video tracks are interleaved into 1000 millisecond blocks and are demultiplexed by the application player during playback.

### CROSS-REFERENCE TO RELATED APPLICATIONS

This application is a continuation-in-part of U.S. application Ser. No. 11/891,892, filed Aug. 14, 2007, which in turn claims the priority of Provisional Application No. 60/837,530, filed Aug. 14, 2006, each of which is incorporated herein by reference in its entirety.

### BACKGROUND OF THE INVENTION

Until now, data-intensive content such as full-length movies has been stored on DVD discs and displayed on devices such as laptop computers, but it has not been stored and displayed with high quality (e.g., DVD quality or better) on miniature hand-held devices such as mobile phones and personal data assistants (PDAs). One of the problems has been to develop a presentation format that provides a fast and efficient system for accessing the content of an optical disc and playing the audio and video content of the disc back at a high level of reproduction quality, without placing undue demands on the microprocessor in the device.

This invention overcomes these problems.

### BRIEF SUMMARY OF THE INVENTION

In accordance with this invention, an optical disc contains a Description File—preferably in XML (Extensible Markup Language), a Control Package File and one or more Presentation Package Files. The XML Description File contains general information about the content of the optical disc, menu information and playlist information. The playlist information contains the names and locations of playback items-Presentation Package Files and the Control Package File. A Presentation Package File contains content (e.g., a movie) that is to be played back. The Control Package File contains a group of graphical, audio or video objects that are used in compositing a menu screen that allows the user to select another menu or a Presentation for playback. The menu screen typically contains buttons that the user may select to trigger actions such as beginning the playback of a presentation or moving on to other screens.

A player application, which may be in the form of software or hardware or both, initially reads the general information and then proceeds to the playlist information, which may point the player application to a Presentation Package File. If the player application is directed to a Presentation Package File, the player application plays back the content of the file or a selected portion thereof. If the player application is not directed to a Presentation Package File, the player application parses the menu information section of the XML Description File and in response uses the objects in the Control Package File to composite a menu screen. The user may interact with the menu or a series of menus to select a Presentation Package File.

The logical data structure defines the data zone of the optical disc in such a way that the data that describes the content of the disc is located near the beginning of the data zone whereas larger files, such as Presentation Package Files, are located closer to the end of the data zone. This increases the efficiency of data access by the player application.

The XML Description File uses a Uniform Resource Identifier (URI) to make sure that the player application references data only in the Control Package File in compositing menus, ensuring that the player application does not search for files in other locations when compositing menus. This minimizes seek times, load times and network connectivity failures.

The player application is responsible for providing only a limited set of application program interface (API) commands, increasing efficiency and reducing the chances of incompatibilities between commands.

The menu information section of the XML Description File is subdivided into data for different display sizes and aspect ratios to ensure that the menus shown on a display are appropriate for the size and aspect ratio of the display.

The video, audio and subtitle data in a Presentation Package File are interleaved into blocks corresponding to a predetermined time interval (e.g., one second). During playback, the audio and subtitle data (if any) are synchronized to the video track, which functions as the master timing track. The player application is capable of playing back multiple audio channels.

To ensure that none of the space for vertical data on the disc is wasted when the source aspect ratio is greater than 16:9, a variable horizontal distortion factor is used to record the data on the disc.

Subtitles are rendered using text data in the Presentation Package File along with font format files in the Control Package File. In contrast to using image files, this reduces the amount of data needed to display subtitles and allows the user to vary the features (color, size, etc.) of the subtitles. This is particularly useful for sight-impaired users.

### BRIEF DESCRIPTION OF THE SEVERAL VIEWS OF THE DRAWING

FIGS. 1A and 1B are perspective and side views of a mobile phone containing a disc drive adapted to display content from an optical disc.

FIG. 2 is a block diagram of the electronic components of the disc drive and mobile phone.

FIGS. 3A-3E contain a flow chart of a method of accessing and displaying data in accordance with the invention.

FIG. 4A is a block diagram illustrating the structure of a XML Description File.

FIG. 4B is a block diagram illustrating the structure of an optical disc containing an XML Description File, a Control Package File and Presentation Package Files.

FIG. 5 is a block diagram showing the logical data structure of the optical disc.

FIGS. 6A and 6B show a document object model of an XML Description File.

FIG. 7 is a block diagram showing the structure of the large and small 16:9 and 4:3 aspect ratio screens in the Menu Information section of an XML Description File and the data used in compositing the screens in the Control Package File.

FIG. 8 is a flow chart illustrating how the video data recorded on a disc is distorted to maximize the vertical resolution.

FIG. 9 is a block diagram illustrating the de-multiplexing and playback of data from an interleaved video/audio track on an optical disc.

FIG. 10 is a block diagram illustrating how the player application composites subtitles using text data from a Presentation Package File and font data from the Control Package File.

### DETAILED DESCRIPTION OF THE INVENTION

A disc according to this invention is played in a device that contains an optical disc drive and a software player environment which is capable of playing back content stored on the disc. Alternatively, the device may contain an optical disc drive and a hardware playback environment. In one embodiment, disc drive is housed within a mobile phone and the content comprises entertainment content such as a full-length movie. In other embodiments the disc drive may be housed within other types of devices, such as PDAs, and the disc may contain other types of content, such as educational content.

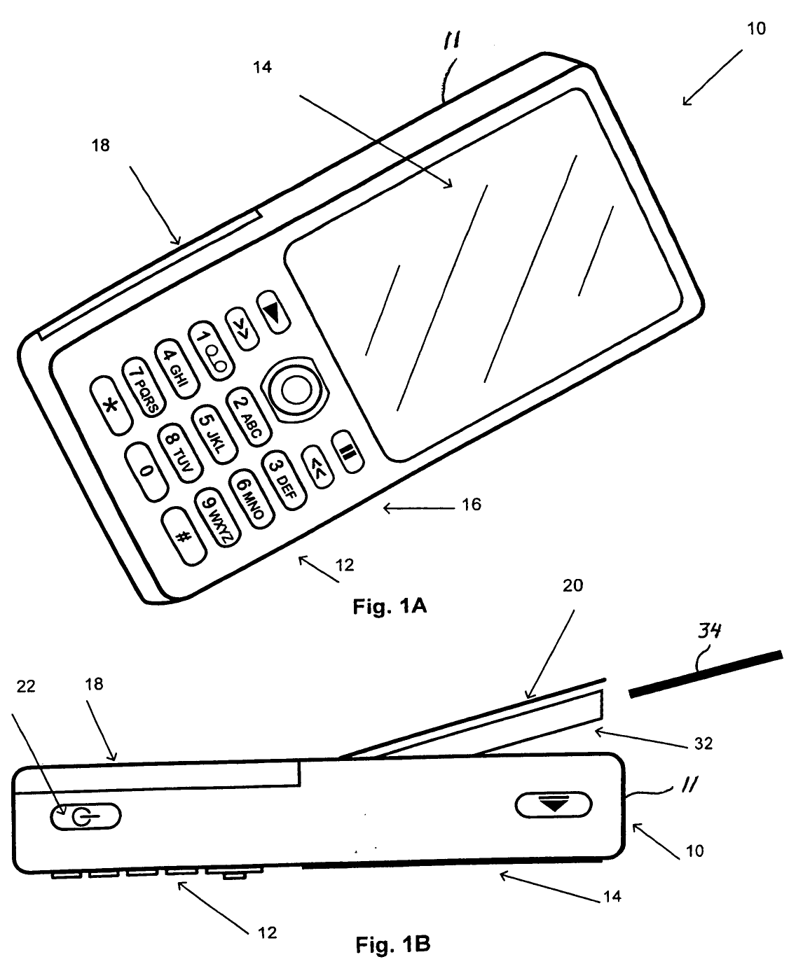

FIGS. 1A and 1B are external views of a mobile phone 10 containing an optical disc drive of the kind described above. The components of mobile phone 10 are enclosed in a housing 11, typically made of plastic. The front side of housing 11 supports a keypad 12 and a video display 14. Between keypad 12 and display 14 is a set of disc drive controls 16, including, for example, “play,” “fast forward,” “pause” and “reverse” buttons. As shown in FIG. 1B, the back side of housing 11 includes a battery compartment access door 18 and an optical disc drive access door 20. When a disc eject button 22 is depressed, drive access door 20 and a cartridge load module 32 swing outward, allowing a cartridge 34 containing the optical disc to be inserted into a cartridge load module 32.

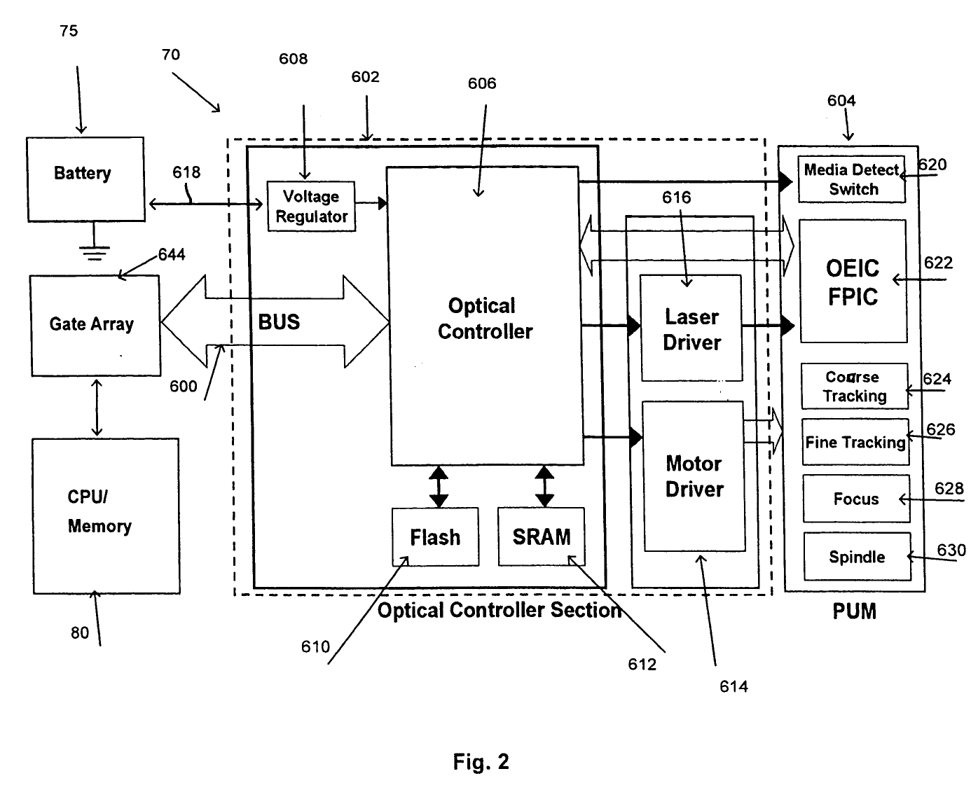

A block diagram of an optical drive 70, a battery 75 and a CPU/memory 80 inside mobile phone 10 are shown in FIG. 2. CPU/memory 80 is connected to optical drive 70 via a bus 600. Optical drive 70 contains two basic components: an optical controller section 602 and a pick-up module 604. The main element of optical controller section 602 is an optical controller IC 606.

The optical controller section 602 also contains a voltage regulator 608, a flash memory 610, a static random-access memory (SRAM) 612, a motor driver IC 614 and a laser driver IC 616. Motor driver IC 614 and laser driver IC 616 receive control signals from the optical controller IC 606. Voltage regulator 608 is powered by a direct connection 618 to battery 75 and is controlled by an on/off control line that is connected to CPU/memory 80 via bus 600.

The other major component of optical drive 70 is pick-up module 604. Pick-up module 604 includes a media detect switch 620, an opto-electric IC and forward photodiode IC (OEIC/FPIC) 622, coarse tracking control circuitry 624, fine tracking control circuitry 626, focus control circuitry 628 and spindle motor control circuitry 630.

The digital controller IC within optical controller IC 606 includes the servo digital signal processor (DSP) required to implement the servo/seek functions of the optical disc drive, the microprocessor required to control the disc drive and the interface between the disc drive and mobile phone 10, the analog-to-digital (A/D) and digital-to-analog (D/A) converters required to interface with optical pick-up module 604, the read-back channel, the encoder-decoder (EnDec), the error correction circuitry (ECC), the media detect switch, and the physical format circuitry.

The front-end processor within optical controller IC 606 includes the analog circuitry required to interface the electronics within the pick-up module 604, such as the OEIC/FPIC 622, with the digital controller IC. The front-end processor also contains the analog electronics required to control motor driver IC 614 and laser driver IC 616 in addition to analog equalizers for the data channel.

Flash memory 610 contains the operating software (firmware) for the microprocessor within optical controller IC 606. SRAM memory 612 can be used to buffer the data being read from optical disc 400.

Motor driver IC 614 is required to drive the carriage drive (coarse tracking) motor 370, the fine servo motor 500, and the motor in spindle assembly 50.

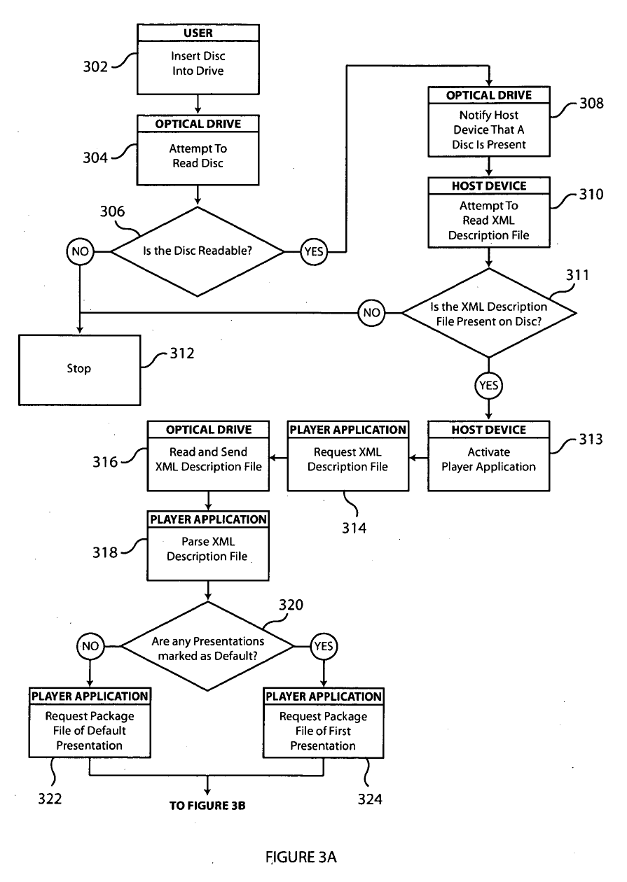

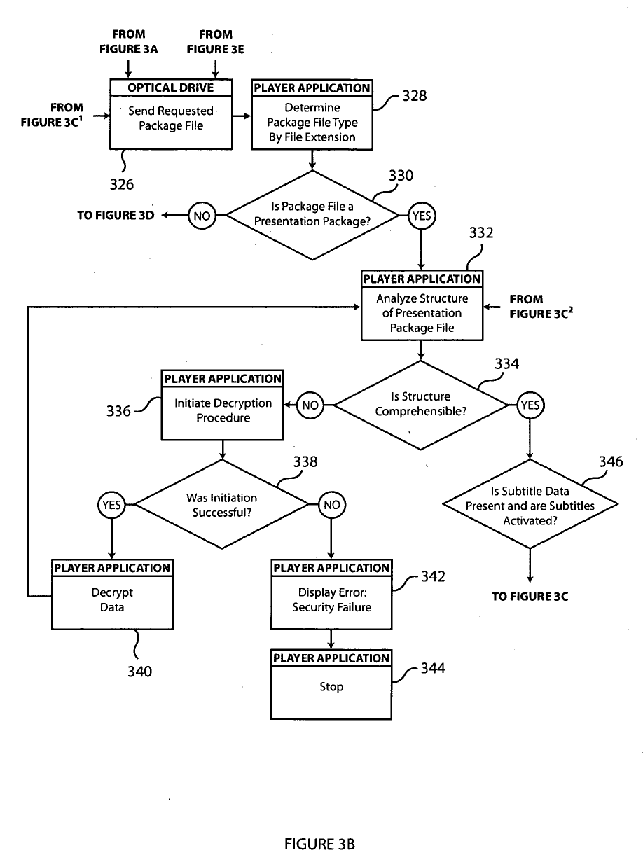

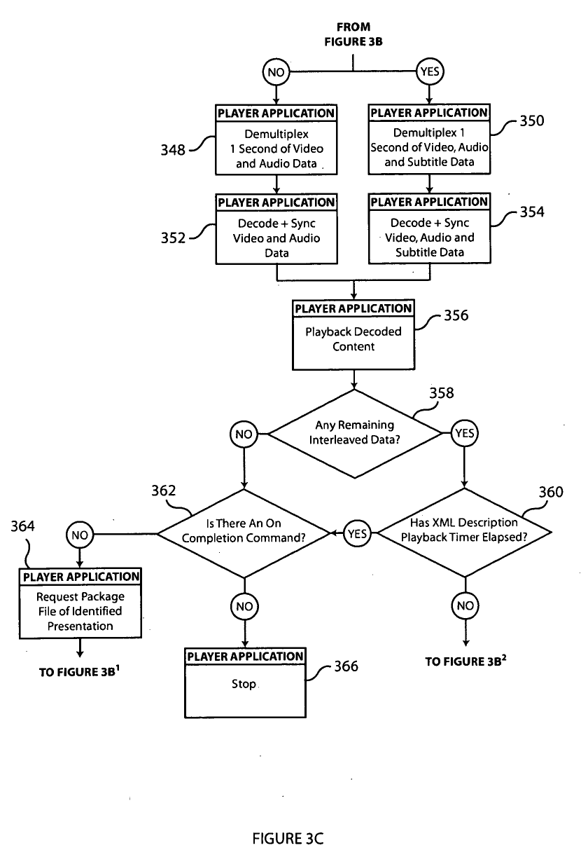

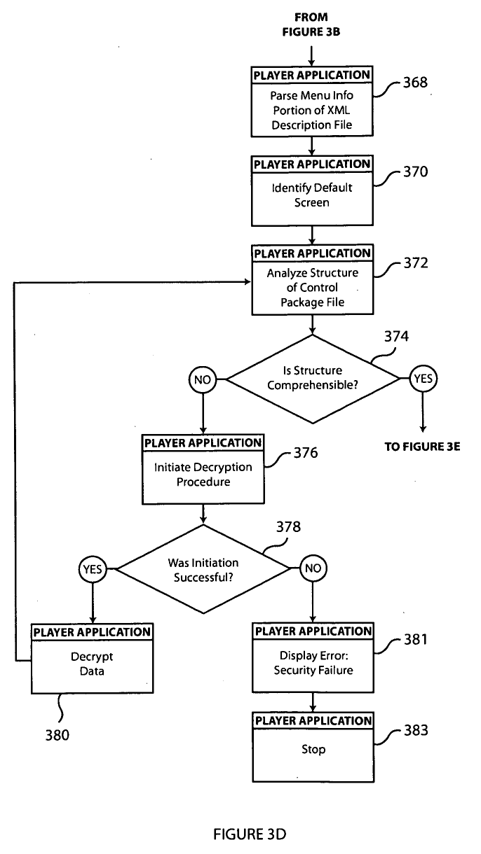

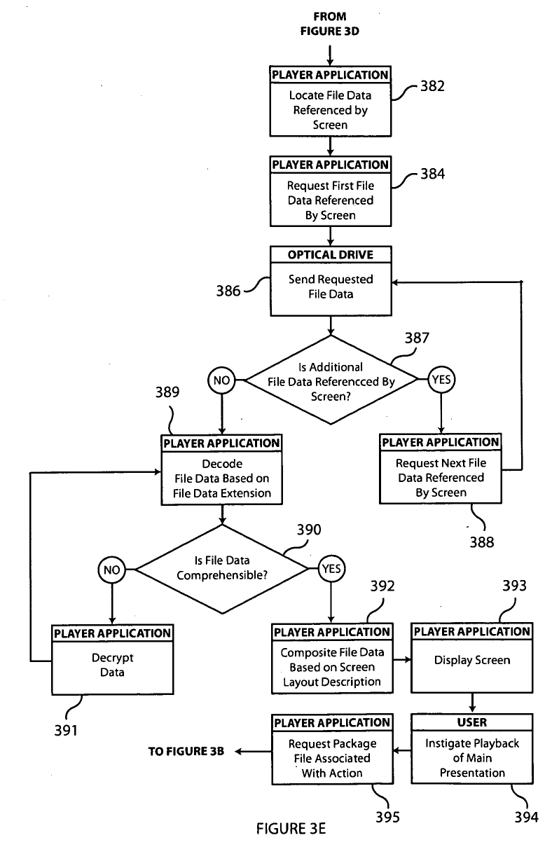

FIGS. 3A-3E contain a flow chart of the process by which the software player (generally referred to herein as the “player application”) accesses data stored on the optical disc. The player application typically resides in a nonvolatile memory included in CPU/memory 80 shown in FIG. 2. Each of the boxes in FIGS. 3A-3E is numbered and contains a heading that indicates whether the particular action is performed by the user, the optical drive, the player application, or the host device (in this embodiment mobile phone 10).

The user begins the process by opening the door 20 and inserting cartridge 34 into mobile phone 10. This is reflected in box 302 of FIG. 3A. Closing the door 20 causes the optical drive to read and identify the type of content stored on the optical disc within cartridge 34 (box 304). If the disc is readable (box 306), the optical drive reports this information to mobile phone 10 or other host device (box 308). If the disc is not readable, the process is terminated (box 312).

The optical disc within cartridge 34 contains a basic Description File, which in this embodiment is in Extensible Markup Language (XML). Mobile phone 10 attempts to read the XML Description File (box 310). If the XML Description File is not present (box 311), the player application does not process the content (box 312).

In another embodiment the optical drive reports the type of content stored on the optical disc as identified by flags in the lead-in portion of the disc. If the disc is marked to contain the type of content specified, the optical drive reports this information to the host device.

In the embodiment described in FIG. 3A, if the XML Description File is present on the disc, mobile phone 10 activates the player application (box 313), which requests the XML Description File (box 314). Optical drive 70 responds by reading the XML Description File and sending it to the player application (box 316).

The player application then begins to parse the XML Description File (box 318). The XML Description File contains a number of “Presentations.” Upon parsing the XML Description File, the player application determines whether any of the Presentations has been marked as the default Presentation (box 320). If one of the Presentations has been marked as the default Presentation, the player application requests the Package File associated with the default Presentation (box 322). If no Presentation is marked as default, the first Presentation listed in the XML Description File is considered the default, and the player application requests a Package File associated with the first Presentation (box 324). In either case, the optical drive 70 responds to the request by sending the requested Package File, which is stored on the disc (box 326).

Next, the player application determines whether the Package File is a Presentation Package File or a Control Package File, as identified by the file name extension (boxes 328, 330). If the package file is a Presentation Package File, the player application analyzes the structure of the file to determine whether it can be read (boxes 332, 334). If the file is encrypted or otherwise unreadable, the player application initiates a decryption procedure (e.g., a Copy Protection for Pre-recorded Media (CPPM) decryption process, as described by the 4C Entity, LLC.) (box 336). The player application then determines whether the decryption was successfully initiated (box 338) and, if so, the player application proceeds to decrypt the data in the file (box 340). If the decryption was not successful, the player application causes an error signal to be displayed (box 342) and stops (box 344).

Once enough of the file has been decrypted the player application analyzes the file to determine its structure (box 332). With the data decrypted, the player application confirms that the file is comprehensible (box 334) and then determines whether subtitle data are present in the file and if the player application has been instructed by the user to activate a subtitle (box 346). Depending on the answer to this question, the player application either demultiplexes blocks containing one second of audio and video data (box 348) or demultiplexes blocks containing one second of audio, video and subtitle data (box 350) and in either case decodes and synchronizes the data (boxes 353, 354) and presents them to the user (box 356).

When the one-second blocks of data have been played back, the player application determines whether there are any remaining interleaved data in the Presentation Package File (box 358) and, if so, whether the time on the XML Description Playback Timer (described below) has elapsed (box 360). If the time on the XML Description Playback Timer has not elapsed, the above-described analysis, decoding and synchronization processes (boxes 332, 334, 346, 348, 350, 352, 354 and 356) are repeated on additional one-second blocks of audio, video and (optionally) subtitle data.

This cycle continues to repeat until either there is no remaining data in the Presentation Package File (box 358) or the time on the XML Description Playback Timer has elapsed (box 360). When either of these conditions is satisfied, the player application determines whether the XML Description File contains an On Completion Command (box 362). Typically, the On Completion instruction specifies another Presentation that is to be accessed (box 364). If so, the player application requests the Package File of the identified Presentation. The optical drive sends the requested Package File to the player application and the player application repeats the process, beginning with the determination of the Package File type (box 328). If there is no On Completion Command, the player application determines whether the XML Description File contains additional Presentations and if so, the player application requests the Package File of the next Presentation listed. The optical drive sends the requested Package File to the player application and the player application repeats the process, beginning with the determination of the Package File type (box 328). If there are no additional Presentations listed in the XML Description File, the player application repeats playback of the current Package File, beginning with the analysis of the structure of the Presentation Package File (box 332). This process continues uninterrupted until the user stops playback.

Referring back to box 330 in FIG. 3B, if the current Package File (as determined by its file name extension) is a Control Package File, the player application parses the Menu Information section of the XML Description File (box 368). The XML Description File contains one or more screens to be shown in display 14 or on an external display with the video signal transmitted through an analog or digital video output port. Together, the series of screens form a menu that is used to access the entertainment or other content on the disc.

The player application identifies the default Screen of the Menu Information section (box 370). A screen may contain graphic, video and audio objects. These objects are referenced by the XML Description File, and the file associated with each object is stored in the Control Package File. Upon parsing the default Screen, the player application analyzes the structure of the Control Package File (boxes 372, 374). If the Control Package File is encrypted or otherwise unreadable, the player application initiates a decryption process (box 376). If the decryption process is successfully initiated (box 378), the player application begins to decrypt the data (box 380) and analyzes the structure of the Control Package File (box 372). If the data in the Control Package File cannot be decrypted, the player application generates an error message and stops (boxes 381, 383).

The player application analyzes the structure of the file to determine whether it can be read (box 372). If the file is encrypted or otherwise unreadable, the player application initiates a decryption procedure (e.g., a Copy Protection for Pre-recorded Media (CPPM) decryption process, as described by the 4C Entity, LLC.) (box 376). The player application then determines whether the decryption was successfully initiated (box 378). If the decryption was not successful, the player application causes an error signal to be displayed (box 381) and stops (box 383). If the decryption was successful, the structure of the Control Package File is analyzed to allow the player application to locate the files referenced by the Screen and stored in the Control Package File (box 382). The player application then requests the first file referenced by the current Screen (box 384), and optical drive 70 responds by sending the file to the player application (box 386). For each additional file referenced by the Screen (box 387), the player application requests the appropriate file from the optical drive (box 388). Once each file of the Screen has been received, the player application decrypts (if applicable) and decodes the files referenced by the Screen (based on their file name extensions) (box 389). Once the files in the Screen are comprehensible, the player application uses the Screen layout description to composite the Screen for presentation to the user (boxes 392, 393).

A Screen typically provides a graphical interface that allows the user to obtain access to at least one Presentation Package File, activation of alternate audio and/or subtitle tracks for a Presentation Package File and potentially to additional Screens. Objects defined in a screen may have actions associated with them that instruct the player application. The user has the option of instigating these actions by means of navigating through the objects of the Screen and selecting one. These objects are referenced by the XML Description File, and the file associated with each object is stored on the disc. The player application requests the files referenced by the screen. Once each file of the screen has been received by the player application, the player application decrypts (if applicable) and decodes the file and begins to use the screen layout description to composite the screen for presentation to the user on display 14 or on an external display with the video signal transmitted through an analog or digital video output port. Thus screens are built from the definition listed in the XML Description File and the graphic, audio and video objects stored in the Control Package File on the disc.

Ultimately, the user initiates playback of the main presentation by means of instigating that action via the graphical interface provided by the Menu Information Screen description (box 394). In response, the player application requests the Presentation Package File associated with the user's request (box 395), and the playback process beginning with box 332 in FIG. 3B commences.

To summarize, the Screens of a Menu provide the user with control over the playback of Presentation Package Files. Screens are built from the definition listed in the XML Description File and the graphic, audio and video objects stored in the Control Package File. Presentation Package Files contain audio, video and (optionally) subtitle data that is presented to the user sequentially.

With that overview, the aspects of the invention will now be described in greater detail.

### XML Description File

The XML Description File contains general information, file locations, menu layout and functionality and video/audio presentation information for the content stored on the disc. The basic XML Description File contains three types of information:
General Information
Playlist Information
Menu Information

The General Information section is provided to allow a content owner to easily identify the content associated with a given XML Description File, for example, the title of the main content and a copyright notice.

The Playlist Information section is provided to allow the player application to locate the Control Package File and any Presentation Package Files. Additionally, time code information can be supplied to allow the player application to locate specific sections within a Presentation Package File for playback, and subtitle information can be supplied to associate a set of subtitle text data contained within the Presentation with a font format file contained within the Control Package File.

The Menu Information section is provided to allow the player application to present an organized system of access control to the user in the form of a graphical interface. This graphical interface, for example, allows a user to select a presentation to view, to specify whether an alternative audio track should be used and which one, to specify whether a subtitle track should be used and which one, and to access a sub-menu.

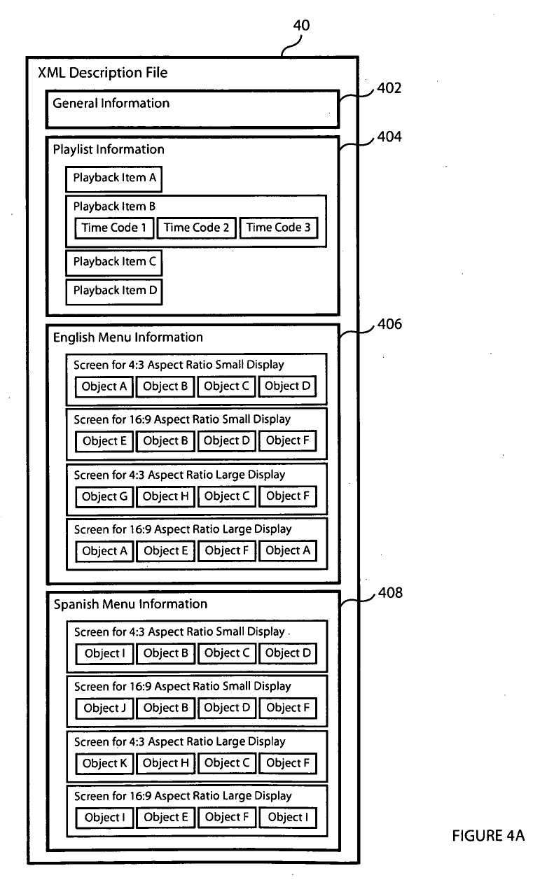

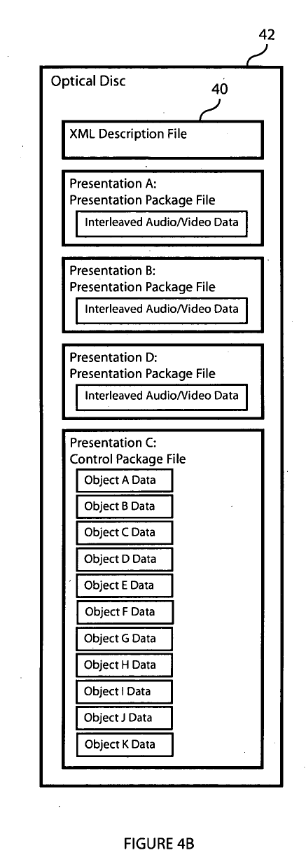

FIGS. 4A and 4B are block diagrams that illustrate the structure of an XML description file and an optical disc containing the XML description file, respectively. As shown in FIG. 4A, XML Description File 40 contains a General Information section 402, a Playlist Information section 404, an English Menu Information section 406 and a Spanish Menu Information section 408. Optical Disc 42 contains XML Description File 40 and Presentations A, B, C and D. Presentations A, B and D are associated with Presentation Package Files, each of which contains interleaved audio/video data. Playback Item C is associated with the Control Package File which contains Objects A through K.

When the optical disc 42 is inserted into a disc drive, the player application first reads the General Information section 402 which, as described above, contains generally descriptive information of the content stored on the disc, such as the full title and a copyright notice. The player application then proceeds to the Playlist Information section 404. If no Presentation is designated as the default, the player application proceeds to the first Presentation, in this case Presentation A shown in FIG. 4B, which as indicated is a Presentation Package File containing interleaved audio/video data.

Alternatively, Presentation B could be designated as the default, in which case the player application would proceed first to Presentation B. As shown in FIG. 4A, Presentation B includes three time codes (Time Code 1, Time Code 2 and Time Code 3), which allow the user to play back a selected portion of Presentation B and/or begin play back at one of the available time codes. Therefore, the player application proceeds to Presentation B, which as indicated is another Presentation Package File containing interleaved audio/video data. If, for example, the user had selected the material associated with Time Code 2 by means of the Menu Screen, the player application would proceed to the material associated with Time Code 2 in the Presentation B shown in FIG. 4B. At a later time, the user might select the material associated with Time Code 3, in which case the player application would proceed to the material associated with Time Code 3 in the Presentation B.

At some point the player application could receive a command to go to Presentation C. As a result, the player application would proceed to Presentation C which, as shown in FIG. 4B, is the Control Package File for disc 42. Presentation C contains Objects A through K. The player application would then proceed to the Menu Information section of XML Description File 40, specifically, either the Menu Information section marked as default (if such a mark is present) or the first Menu Information section if no section is marked as default. In either case, the Menu Information section contains a list of graphic layout screens that are presented to the user to provide access to and control over the Presentation Package Files on disc 42 as well as access to other screens. Each screen is composited using a selected group of objects that are stored in the Control Package File associated with Presentation C. As shown and described further below, there are variations of each screen for small and large displays and for displays having 4:3 or 16:9 aspect ratios. A single screen typically provides a graphical interface to the user to obtain access to at least one presentation and potentially to additional screens. Objects defined in a screen may have actions associated with them that instruct the player application. The user has the option of instigating these actions by means of navigating through the objects of the screen and selecting one.

### Logical Data Structure

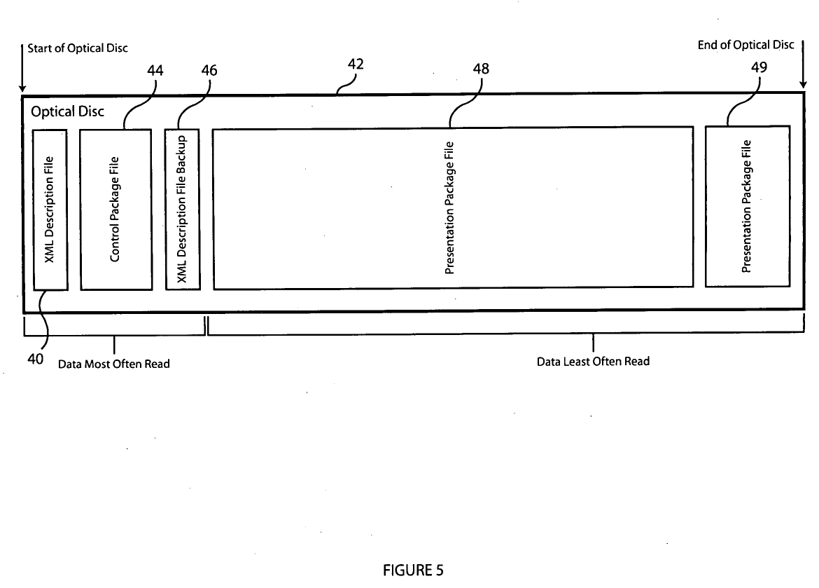

The Logical Data Structure of disc 42 is illustrated in FIG. 5. The Logical Data Structure defines the video zone of disc 42 in such a way that the data that describes the primary content of disc 42—the XML Description File 40 and the Control Package File 44 (Presentation C)—is located at the start of the video zone to allow efficient location and access by the player application. Larger data files, such as Presentation Package Files 48 and 49, are located at the end of the video zone. This allows the player application to avoid seeking to the end of the video zone in order to access data files that describe the content located on the disc, increasing data access efficiency. In one embodiment, there may be up to 99 Presentation Package Files. Disc 42 also contains a Volume and File Structure Zone which contains information describing the locations of files and directories on the disc.

A backup copy 46 of the XML Description File 40 is stored in a sub-zone that is at least one error correction code (ECC) block removed from the original XML Description File 40. This increases the likelihood that either XML Description File 40 or the backup copy 46 will be accessible by the player application with no read errors.

If the content of disc 42 is encrypted, a sub-zone containing the decryption file(s) (e.g., CPPM) may be included between the backup copy 46 and the Presentation Package Files 48 and 49.

### Validation of XML Description File

As described above, access to the data on the disc is controlled and defined by the XML Description File. The XML Description File is normally generated by the owner of the content on the disc, which is stored in the Presentation Package Files. To ensure that discs designed by different content owners are compatible with a single player application, the structure of the XML Description File is limited to a specific series of elements and attributes. The elements and attributes in the XML Description File must be in accordance with and valid to a master XML schema. This ensures that the parsing engine of the player application for the XML Description File will have full comprehension of the elements and attributes of the XML Description File. A content owner can therefore create an XML Description File and validate it to the master XML schema prior to committing the XML file to the replicated discs while ensuring that there are no errors due to the invalid use of any elements or attributes.

A single XML document, named CL1description.xml, is located at the root of the disc file system. The CL1description.xml document is created during content authoring and may be required to be validated against a schema document. Preferably, the schema document is valid to the W3C XML Schema, which can be found at http://www.w3.org/2001/XMLSchema.

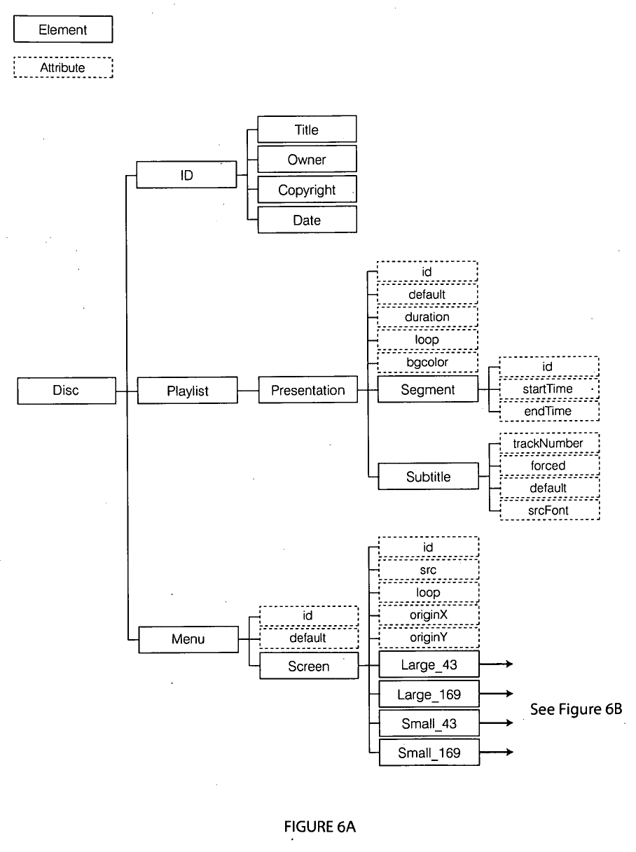

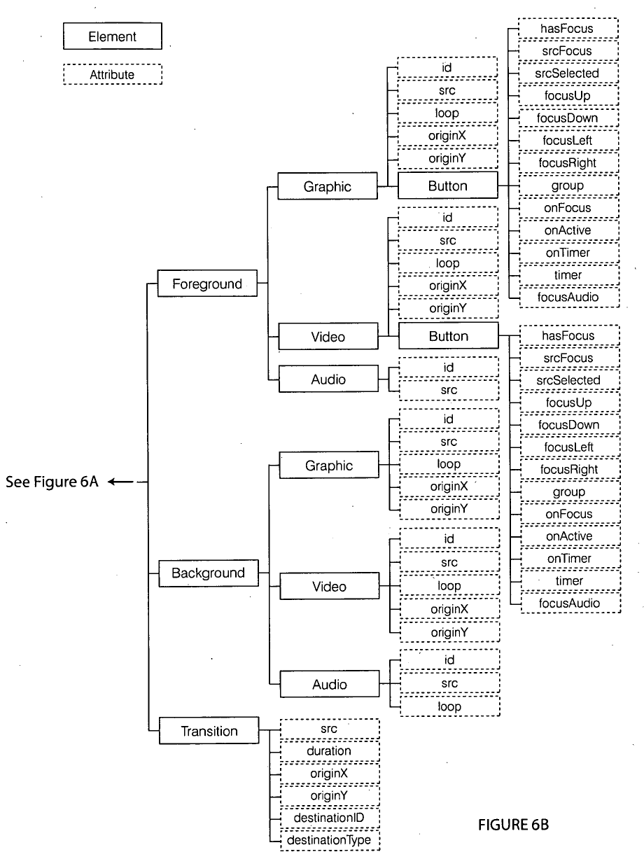

A document tree of the elements and attributes in the XML master schema is illustrated in FIGS. 6A and 6B. The Appendix contains a representation of the syntax of the XML master XML schema, including series of tables showing, for each element or attribute in the master XML schema:
(a) the parent element of the element or attribute,
(b) whether the element or attribute is required,
(c) a list of any possible attributes applicable to the element,
(d) a list of any possible child elements of the element,
(e) if applicable, the XML data type, as defined in the XML Part 2: Data Types specification, found at http://www.w3.org/TR/2004/REC-xmlschema-2-20041028/
(f) any restrictions on the value of the element or attribute,
(g) the default value (i.e., the value of the element or attribute if the element or attribute is excluded from the XML Description File or included but empty),
(h) the minimum number of times that the element or attribute may be included within the parent element (or in the case of the root element, the XML document),
(i) the maximum number of times that the element or attribute may be included within the parent element (or in the case of the root element, the XML document), and
(j) an example of an implementation of the element or attribute.

### Referencing Menu Resource Files

As described above, the graphic, audio and video data files that are resources of a menu (Menu Resource Files) are stored in the Control Package File. To enable the player application to access these data files independently from any other data files stored in the Control Package File, a Uniform Resource Identifier (URI), as defined in URI, RFC3986, is used in the XML Description File. These files are referenced according to the URI syntax and the identification syntax as defined in section 8.44.7 of the ISO 14496:2005 ISO Base Media File Format specification. The function of the URI is to exclusively reference data contained in the Control Package File. This limitation ensures that the player application will not need to search for data files in variable locations, such as locations on a network. This minimizes seek times, load times and network connectivity failures.

An example of a URI referencing a Portable Network Graphic (PNG) file located in the Control Package File is as follows:

file:///disc/CPACK/CL1.cpack#item_name=sunshine.png

This URI refers to the sunshine.png file that is stored within the CL1.cpack file in the CPACK directory on the disc.

### Application Program Interface Commands

A limited set of application program interface (API) commands is defined for use in an XML Description File. By limiting the set of available commands, the player application is responsible for providing a limited set of functionality, and the possibility of incompatibilities between commands is lowered. The commands are play, playReturn, show and setTrack:

play( )

The play( ) command is used to start playback from the beginning of a Presentation or at the start of a Segment of a Presentation. The play( ) command applied to a Presentation will continuously playback the Presentation from the 00:00:00 timecode position until the timecode position reaches the Presentation duration value or until the end of available source content for the Presentation. The play( ) command applied to a Segment will continuously playback the Presentation from the startTime timecode value of the Segment until the timecode position reaches the Presentation duration timecode value or until the end of available source content for the Presentation. Once the playback is complete, the player application will begin playback of the next Presentation, using the first Presentation in the Playlist if no further Presentations exist.

a) If the specified Presentation id does not match an existing Presentation the player application is not required to do anything.

b) If the specified Segment id does not match an existing Segment of the specified Presentation, playback of the Presentation shall commence as if the play( ) command had been applied to the Presentation.

c) If a player application returns to the Menu during playback, the next play( ) command of the same Segment of a Presentation (or Presentation if no Segment was previously specified) prior to playback of any other Segment, playback of any other Presentation, disc ejection, player application stop directive or player application power cycle will resume playback from the point at which the player application returned to the Menu. When applicable, this will override playback from the 00:00:00 timecode or the startTime timecode.

### Syntax:

```
    Disc.Playlist.Presentation[Presentation id].play( );
    or
    Disc.Playlist.Presentation[Presentation
id].Segment[Segment id].play( );
```

Presentation id Required. The id attribute value of the Presentation which is the target of the play( ) command.

Segment [Segment id] Optional. The id attribute value of the Segment within the Presentation which is the target of the play( ) command.

### Examples

Disc.Playlist.Presentation[‘Main Video’].play( );

Begins playback of the ‘Main Video’ Presentation from the 00:00:00 timecode position (unless resuming). Playback continues until the timecode position reaches the Presentation duration value or the end of the available Presentation source content. The player application then goes to the default Screen of the Menu which was active when playback was initiated.

Disc.Playlist.Presentation[‘Main
Video’].Segment[‘Chapter 3’].play( );

Begins playback of the ‘Main Video’ Presentation from the startTime timecode value attributed to the Segment identified as ‘Chapter 3’ (unless resuming). Playback continues until the timecode position reaches the Presentation duration value or the end of the available Presentation source content. The player application then goes to the default Screen of the Menu which was active when playback was initiated.

playReturn( )

The playReturn( ) command is used to start playback from the beginning of a Presentation or at the start of a Segment of a Presentation. The playReturn( ) command applied to a Presentation will continuously playback the Presentation from the 00:00:00 timecode position until the timecode position reaches the Presentation duration value or the end of the Presentation source content. The playReturn( ) command applied to a Segment will continuously playback the Segment from the startTime timecode value of the Segment until the timecode position reaches the endTime timecode value of the Segment. Once the playback is complete, the player application will return to the Screen which activated playback of the Menu which was active when playback was initiated.

a) If the specified Presentation id does not match an existing Presentation the player application is not required to do anything.

b) If the specified Segment id does not match an existing Segment of the specified Presentation, playback of the Presentation shall commence as if the playReturn( ) command had been applied to the Presentation.

c) If a player application returns to the Menu during playback, the next playReturn( ) command of the same Segment of a Presentation (or Presentation if no Segment was previously specified) prior to playback of any other Segment, Presentation, disc eject or player application power cycle will resume playback from the point at which the player application returned to the Menu. When applicable, this will override playback from the 00:00:00 timecode.

Syntax:

```
    Disc.Playlist.Presentation[Presentation
id].playReturn( );
    or
    Disc.Playlist.Presentation[Presentation
id].Segment[Segment id].playReturn( );
```

Presentation id Required. The id attribute value of the Presentation which is the target of the playReturn( ) command.

Segment [Segment id] Optional. The id attribute value of the Segment within the Presentation which is the target of the playReturn( ) command.

### Examples

Disc.Playlist.Presentation[‘Main Video’].playReturn( );

Begins playback of the ‘Main Video’ Presentation from the 00:00:00 timecode position (unless resuming). Playback continues until the timecode position reaches the Presentation duration value or the end of the available Presentation source content. The player application then returns to the Screen which activated playback of the Menu which was active when playback was initiated.

Disc.Playlist.Presentation[‘Deleted
Scenes’].Segment[‘Deleted Scene 1’].playReturn( );

Begins playback of the ‘Deleted Scenes’ Presentation from the startTime timecode value attributed to the Segment identified as ‘Deleted Scene 1’ (unless resuming). Playback continues until the timecode position reaches the endTime timecode value attributed to the Segment. The player application then returns to the Screen which activated playback of the Menu which was active when playback was initiated.

show( )

The show( ) command is used to change the active Menu or the active Menu Screen.

a) If the indicated Menu id is non-existent in the XML Description File, the player application shall ignore the show( ) command.

b) If the indicated Screen id is non-existent in the current Menu, the player application shall make the default Screen of the current Menu the active Menu Screen.

Syntax:

Disc.Menu[Menu id].show( );
Disc.Menu.Screen[Screen id].show( );

Menu id Required when targeting a Menu. The id attribute value of the Menu which is to become the active Menu.

Screen id Required when targeting a Screen. The id attribute value of the Screen within the currently active Menu which is to become the active Menu Screen.

### Example

Disc.Menu.Screen[‘Main Menu’].show( )
Changes the active Menu Screen to the Screen identified as ‘Main Menu’.

setTrack( )

The setTrack( ) command is used to specify which track is the active track within a specific Presentation. It can be used to specify the track id for audio playback or the track id for subtitle playback.

a) If the indicated track id is non-existent or of the wrong type, the player application shall decrement the value of id until it matches an existing track id of the same type (audio or subtitle). If the track id is decremented to 0, no track of the specified type will be active.

b) A subtitle track set to 0 will turn off any active subtitles. If the optional Button id parameter is present in the setTrack( ) command and the value corresponds to the id attribute of a button graphic or video object in the current Screen type, that specified graphic or video object will receive focus after the setTrack( ) command has been processed.

Syntax

Disc.Playlist.Presentation[Presentation
id].setTrack(type, id, Button id)

Presentation id Required. The id attribute value of the Presentation for which the setTrack( ) command is to be performed.

type Required. A value of either audio or subtitle.

id Required. A positive integer value specifying the track that shall be selected. Must correspond to a track id of the same type as specified in the type parameter.

Button id Optional. The id attribute value of a graphic or video object which includes a Button element and is within the same Screen type as the Button element which activated the setTrack( ) command.

### Example

Disc.Playlist.Presentation[‘Behind The
Scenes’].setTrack(‘audio’,2,‘Subtitles Off’)

Selects the audio track id #2 of the ‘Behind The Scenes’ Presentation and then applies focus to the graphic or video object with an id attribute value of “Subtitles Off”.

To summarize, there are only four API commands, and two of these commands have variants that may be addressed to either a Presentation Package File or a segment within a Presentation Package File. The commands include the ability to begin playback of a presentation, begin playback of a presentation at a specific time in the presentation as cross-referenced to an element contained in the XML Description File, begin playback of a presentation and return to the graphical interface screen that contained the command to initiate playback, begin playback of a presentation at a specific time in the presentation as cross-referenced to an element contained in the XML Description File and return to the graphical interface screen that contained the command to initiate playback, change graphical interface screens from the current screen to another screen defined in the XML Description File, set the audio or subtitle track that will be used during playback of a presentation.

By limiting the set of available commands that the player application is responsible for exhibiting, the possibility of incompatibilities between commands is lowered.

### Menu Screen Mapping to Output Display Aspect Ratio and Size

The dimensions and positions of various graphical features of a menu screen need to be altered depending on the size and aspect ratio of the display on which the screen is shown. For example, a button that is properly sized to be visible on a mobile phone display may be much too large if displayed on a 42″ flat panel television. Conversely, the button displayed appropriately on a 42″ flat panel television may be nearly invisible when displayed on the display of a mobile phone. Additionally, a layout optimized for a 16:9 display would be suboptimal when rendered on a 4:3 display, and vice versa.

To overcome this problem, the elements and attributes of the XML Description File that control the layout, display size, cropping and visibility of each object are grouped into four types:
4:3 Aspect Ratio Small Screen
4:3 Aspect Ratio Large Screen
16:9 Aspect Ratio Small Screen
16:9 Aspect Ratio Large Screen

By enabling four distinct groups of elements and attributes for the two most common display aspect ratios and for large and small displays, the designer of the disc can reuse graphic and video objects and adjust layout for any screen of the access control graphical interface while ensuring that the presentation to the end user will be appropriate to the display device. The player application can have an option that allows the end user to specify the display aspect ratio and size and/or the player application can be set for a specific known display aspect ratio and size. When compositing the access control system graphical interface, the player application uses the elements and attributes associated with the specified display aspect ratio and size.

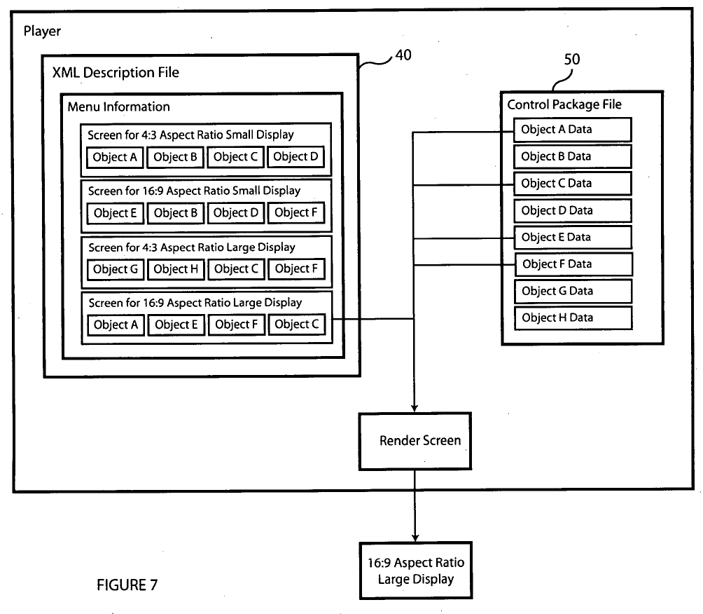

For example, FIG. 7 is a block diagram of the Menu Information section of XML Description File 40. Included are four versions of the same screen for the different screens sizes and aspect ratios listed above. Also shown in FIG. 7 is a Control Package File 50, which contains Objects A through H that are used in compositing the menu screens. As indicated, for a large display having a 16:9 aspect ratio, the player application uses Objects A, C, E and F, which together form a menu suitable for a display of that description. If the display had an aspect ratio of 4:3 instead of 16:9, Objects G and H would be substituted for Objects A and E. If the display were small instead of large, Objects B and D would be substituted for Objects A and C.

As shown in FIGS. 6A and 6B and the corresponding tables of the Appendix, Large_{—}43, Large_{—}169, Small_{—}43 and Small_{—}169 are child elements of the element Screen. For each type (Large_{—}43, Large_{—}169, Small_{—}43 and Small_{—}169) of element there are Foreground and Background child elements. Each Foreground and Background element can contain Graphic, Video and Audio child elements. Each Graphic and Video element can contain a Button child element. The Graphic, Video and Audio elements of a specific Foreground or Background element will be used when rendering the screen type (Large_{—}43, Large_{—}169, Small_{—}43 or Small_{—}169) that is the parent element of the Foreground or Background element. All other Graphic, Video and Audio elements are ignored during the rendering of the selected screen type element.

This invention is not limited to four categories defined by two screen sizes and two aspect ratios but includes embodiments in which three or more screen sizes and/or aspect ratios are used. For example, six categories may be defined using small, medium and large screens and 4:3 and 16:9 aspect ratios.

The display frame of the screens which constitute the access control system is quantified in pixels to match the common sizing methodology of graphical content creation applications and output displays.

### Scaling

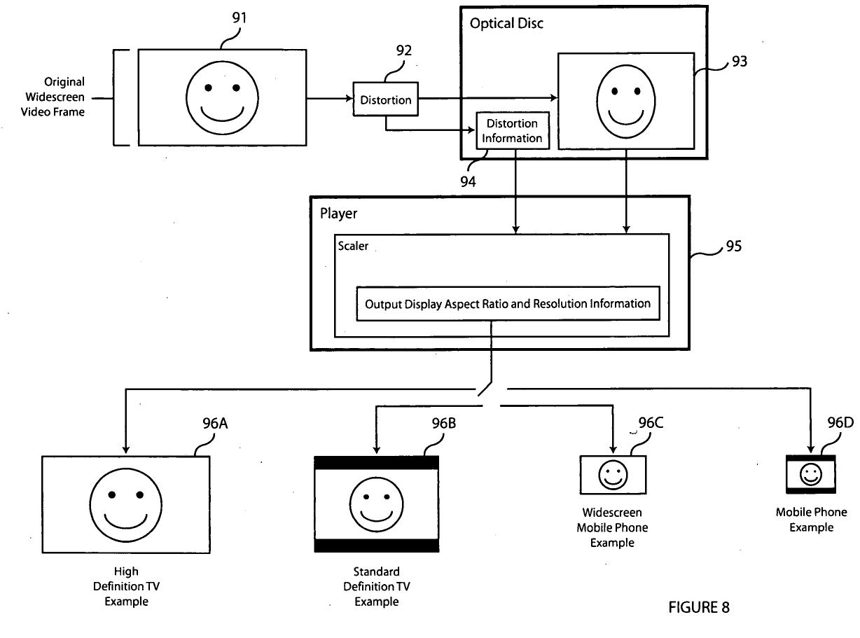

Since the human eye resolves more detail on the vertical axis than on the horizontal axis, it is known in the prior art to distort or compress the content of a frame horizontally in order to provide a higher degree of information valuable to the human eye in the displayed frame. For example, as shown in FIG. 8, an original widescreen video frame 91 is intentionally distorted (box 92) before the frame is recorded on the optical disc as frame 93. This in effect reduces the total amount of data that has to be recorded on the disc while maintaining the amount of vertical data. The distortion factor is also recorded on the disc (box 94), the distortion factor being equal to the number of pixels on the horizontal axis in frame 91 divided by the number of pixels on the horizontal axis in frame 93. The original frame 91 would typically be recorded on film, magnetic tape or a hard disk.

When the disc is played, the player uses the distortion factor to reverse the compression and to display a frame 96A-96D having the same aspect ratio as the source frame 91. While some of the horizontal information is lost in this process, the viewer experience is optimized by maintaining a greater proportion of the vertical information.

In a DVD disc, the maximum number of pixels along the horizontal axis of a standard definition frame is 720 and the maximum number of pixels along the vertical axis of a standard definition frame is 576. DVD-Video technology includes a method of the kind described above for increasing vertical information at the sake of horizontal information. That method is limited to a single distortion factor regardless of source aspect ratio. Therefore, vertical information cannot be maximized in all cases, specifically, in cases where the source aspect ratio is wider than 16:9. An informal review of distributed DVD-Video discs indicates that approximately 40% may be recorded from content provided at greater than a 16:9 source aspect ratio.

A standard 16:9 aspect ratio frame has 1024 pixels on the horizontal axis and 576 pixels on the vertical axis. When the source aspect ratio is wider than 16:9, DVD technology first scales the information down along both axes so that it fits within 1024 pixels on the horizontal axis and then compresses the horizontal axis to fit within 720 pixels to record the data on a standard definition 720×576 pixel frame on the disc.

For example, assume that the source frame measures 1920×800 pixels, which represents a source aspect ratio of 2.4:1 (wider than 16:9). In this situation, the DVD technology scales both axes such that the horizontal axis occupies 1024 pixels without changing the aspect ratio. Thus, the 1920 pixels on the horizontal axis are first compressed to fit within 1024 pixels. This equates to a scaling factor of 1.875 to 1. To maintain the same aspect ratio, the vertical axis is also scaled down by the same factor of 1.875 to 1 to yield 426.6 pixels (i.e., 800 divided by 1.875 equals 426.6). To store the frame on the disc, the horizontal axis is then distorted by a factor of 1.422 (1024 divided by 720) while the vertical axis remains at 426.6 pixels. As a result, approximately 150 vertical pixels, or about 35% of the total of 576 vertical pixels, are not used to store picture information.

Using the method of this invention, the maximum vertical resolution of this source content is limited only by the maximum vertical resolution of a standard definition frame, 576 pixels. In order to determine the distortion factor required the source frame width is divided by the maximum encoded frame width of 720 pixels and the source frame height is divided by the maximum encoded frame height of 576 pixels. In the example, 1920 divided by 720 is approximately 2.667 and 800 divided by 576 is approximately 1.389. These two results comprise the distortion factor as the ratio of 2.667 to 1.389. Evaluating that ratio results in 1.92. Verifying that 1.92 is the accurate distortion factor is accomplished by determining the source frame aspect ratio (1920 width divided by 800 height, equals 2.4) and multiplying the encoded frame width by the distortion factor (720 width multiplied by 1.92, equals 1384.2) and then dividing that result by the encoded frame height (1384.2 divided by 576 height, equals 2.4). The source frame aspect ratio matches the aspect ratio of the encoded frame after the distortion factor has been applied to restore the frame to an undistorted state.

Using the method described herein as compared with the method employed by DVD-Video, an increase of approximately 150 pixels (nearly 35%) of vertical information is gained. Any display device with a resolution greater than 1024 pixels in the horizontal axis and 426 pixels in the vertical axis will be capable of taking advantage of the increased vertical information.

In short, the prior art technique uses a single horizontal distortion factor which in many cases will result in a significant portion of a standard definition frame not being used to store picture information. In contrast, in accordance with this invention the horizontal distortion factor may be varied by the disc designer based on the source aspect ratio to permit the storage of picture information within a full standard definition frame on an optical disc.

Since a pixel is a non-divisible unit, rounding errors are expected. In some cases the aspect ratio of the evaluated frame to be rendered may differ very slightly from the source aspect ratio. This is expected and understood to be of such small discrepancy as to not adversely affect the displayed video frame. The difference is minor enough that the human eye would not be capable of discerning it. The author of the content on the disc may calculate the distortion factor using the algorithm described below. The known values, which are the inputs to the algorithm, are the following:
Sw, the Source Frame Width, is the width of the source frame measured in pixels, assuming a pixel aspect ratio of 1:1.
Sh, the Source Frame Height, is the height in the source frame measured in pixels, assuming a pixel aspect ratio of 1:1.
FPS, Frames Per Second, is the number of frames displayed per second of the source material as originally captured.

TEw, or the Target Encoded Frame Width, is the up or down scaling target that the content author will use for the Encoded Frame Width. The value of TEw is technically limited by the maximum number of macroblocks per second (pixels rendered per second) allowed by the video encoding technology. In this method the limit is commonly known as “Standard Definition” with a maximum value of 720.

```
IF (Sw LESS THAN 720) {
    TEw = Sw
} ELSE {
    TEw = 720
}
```

TEh, or the Target Encoded Frame Height, is the up or down scaling target that the content author will use for the Encoded Frame Height. The value of TEh is technically limited by the maximum number of macroblocks per second (pixels rendered per second) allowed by the video encoding technology. In this method, the limit is commonly known as “Standard Definition” with a maximum value of 576 for 25 FPS content and 480 for 30 FPS content.

```
IF (FPS LESS THAN OR EQUAL TO 25) {
    IF (Sh LESS THAN 576) {
        TEh = Sh
    } ELSE {
        TEh = 576
    }
} ELSE {
    IF (Sh LESS THAN 480) {
        TEh = Sh
    } ELSE {
        TEh = 480
    }
}
```

PARw, or the Pixel Aspect Ratio, Width value, is the width value of the width to height distortion factor ratio.

PARW=Sw/TEw

PARh, or the Pixel Aspect Ratio, Height value, is the height value of the width to height distortion factor ratio.

PARh=Sh/TEh

Using the known input values, a content author calculates the Target Encoded Width, Target Encoded Height and distortion factor (ratio of PARw to PARh) of the encoded video content for storage on the disc, scaling the Source Frame to the Target Encoded Frame values. This method enables the preservation of the source aspect ratio while maximizing vertical information.

The majority of source content will have one of the industry standard frame rates: 23.976, 24, 25, 29.97 or 30 frames per second. Some unique content may have other values. The Target Encoded Height is constrained by the total number of macroblocks per second (pixels rendered per second). For Standard Definition content this value is calculated to 10,368,000 pixels per second.

720*480*30=10,368,000

720*576*25=10,368,000

Content with more than 25 FPS but less than 30 FPS may be optimized during content authoring to leverage more vertical information. For example, 29 FPS content may have a maximum height of 496.

10,368,000/720/29=496.55

Using advanced upscaling methods it may be possible for the content author to use a Target Encoded Width and/or Target Encoded Height value that is larger than the Source Width and/or Source Height value in order to produce a more detailed rendered picture during playback. Since upscaling in the content authoring stage is not dependent on real time processing as it is in the playback stage, more complex scaling algorithms could be used to increase quality over the scaling algorithms used during playback. In this case, the Target Encoded Width value would be fixed at 720 pixels and the Target Encoded Height value would be fixed at the maximum number of pixels allowed in Standard Definition content at the source frame rate, regardless of whether the Source Frame Width and/or Height are less than those values.

Once the Target Encoded Width, Target Encoded Height and distortion factor have been calculated, the Target Rendered Width and Target Rendered Height for playback are calculated. The known input values are:
Dw, or the Display Frame Width, is the width of the display frame, measured in pixels.
Dh, or the Display Frame Height is the height in pixels of the display frame, measured in pixels.
Dpar, or the Display Pixel Aspect Ratio, is the ratio of width to height of an individual pixel as rendered on the display. For NTSC television, this value is 8:9. For PAL television, this value is 16:15. For most other displays such as digital televisions and computer displays, this value is 1:1.
Ew, or the Encoded Frame Width, is the width of the encoded frame stored on the disc, measured in pixels (which is the same as the Target Encoded Frame Width (TEw) in the earlier calculation).
Eh, or the Encoded Frame Height, is the height of the encoded frame stored on the disc, measured in pixels (which is the same as the Target Encoded Frame Height (TEh) in the earlier calculation).
Epar, or the Encoded Frame Pixel Aspect Ratio (distortion factor), is the distortion factor used to store the source frame on the disc as the encoded frame. A width to height ratio of distortion applied to the source frame that resulted in the encoded frame. The ratio of the PARw and PARh values stored with the encoded content on the disc.

The values to be calculated are the following:

Dar, the Display Aspect Ratio, is the aspect ratio of the display frame.

Dar=Dw*Dpar/Dh

Sar, the Source Aspect Ratio, is the aspect ratio of the source frame.

Sar=Ew*Epar/Eh

TRh, the Target Rendered Frame Height is the up or down scaling target that the player application will use for the rendered video frame height, applied to the Encoded Frame Height.

```
IF (Dar GREATER THAN OR EQUAL TO Sar) {
    TRh = Dh
} ELSE {
    TRh = Dw * Dpar / Sar
}
```

TRw, the Target Rendered Frame Width, is the up or down scaling target that the player application will use for the rendered video frame width, applied to the Encoded Frame Width.

```
IF (Dar LESS THAN OR EQUAL TO Sar) {
    TRw = Dw
} ELSE {
    TRw = TRh * Sar / Dpar
}
```

Using the known input values, a player application will calculate the Target Rendered Width and Target Rendered Height of the video content for playback, scaling the Encoded Frame to the Target Rendered Frame values. This method preserves the source aspect ratio while using the distortion factor to maximize vertical information.

It is recognized that some hardware environments may constrain the degree of down scaling of the encoded frame to the target rendered frame. In these cases, it may be necessary to implement methods such as discarding every other line from top to bottom and/or frame cropping in order to achieve a rendered frame that most closely approaches the full source frame on the display.

### Track Playback Synchronization

The audio, video and (optionally) subtitle tracks stored in a Presentation Package File are interleaved into blocks (samples) of 1000 milliseconds of content. Each block of content in a Presentation Package File is comprised of a synchronized one-second sample of each audio, video and subtitle track. This allows the player application to extract a synchronized one-second sample of each track required during playback and decode each of those samples at the same time. Playback of the samples is then synchronized to the video track, which is the master timing track.

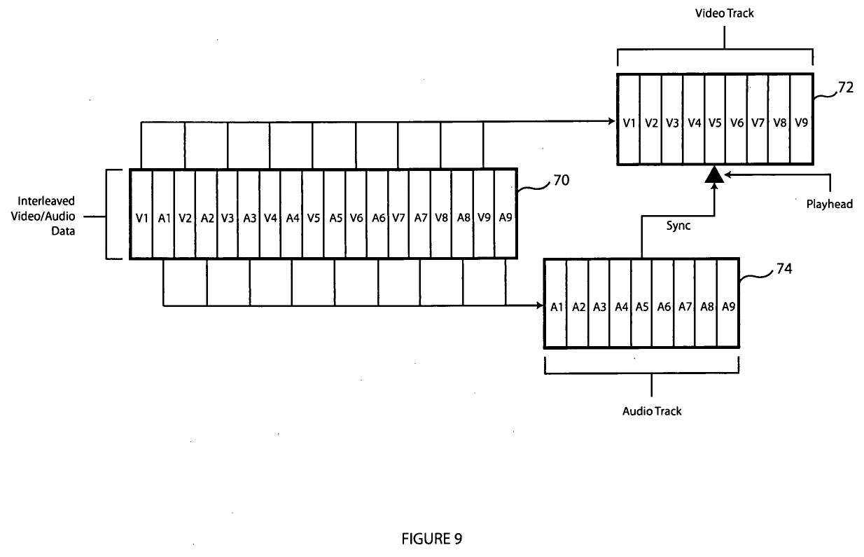

This is illustrated in FIG. 9, which shows conceptually an interleaved audio/video track 70 stored on the optical disc. Track 70 contains one-second video blocks V1, V2 . . . V10 and one-second audio blocks A1, A2 . . . A10. The player application demultiplexes track 70 into a video track 72 and an audio track 74, each of which contains the one-second blocks of data in succession, and then plays back the data such that video block V1 is played simultaneously with audio block A1, video block V2 is played simultaneously with audio block A2, etc. Track 70 could also contain subtitle blocks S1, S2 . . . S10, and each of the audio blocks could contain two or more audio tracks. In each case, during playback all of the one-second blocks of audio and subtitle data would be synchronized to the video track.

### Subtitles and Fonts

The subtitle blocks in the interleaved video/audio/subtitle data track in a Presentation Package File, contain text data—such as ASCII data—identifying the words to be shown in the subtitles. Text data require relatively small amounts of storage space; ASCII data representing a single English language character, for example, contains only one byte of data.

The Control Package File contains a font format file such as an OpenType Font format file. During playback and compositing of the subtitle information onto the display frame, the player application uses both the text data stored in a Presentation Package File and the OpenType Font format files stored in the Control Package File to composite the subtitles to be shown on the display. This ensures that the typographic information necessary to display the proper character shapes of any given language used by the subtitle track is available to the player application, regardless of the player application's built-in or lack of built-in character shape rendering capability. It also allows the user to alter the features of the subtitles as reproduced on the display (color, size, etc.). For example, sight-impaired users may increase the size of the subtitles. It requires less data storage than prior art systems such as DVD which store subtitles as image files.

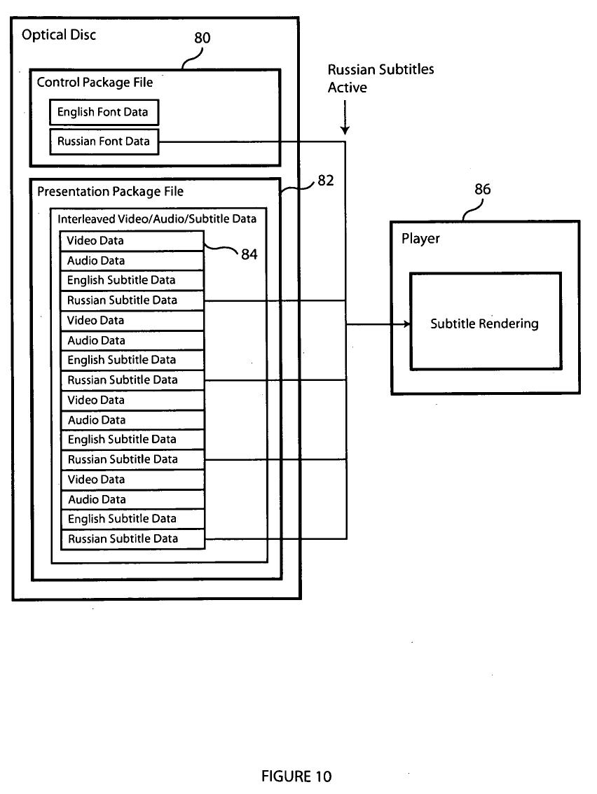

This technique is illustrated in FIG. 10, wherein Control Package File 80 contains English Font data and Russian Font data. The interleaved video/audio/subtitle track 84 within Presentation Package File 82 contains English Subtitle text data and Russian Subtitle text data. When the user has selected the Russian Subtitle data for activation the player application 86 reads the Russian Subtitle data in track 84 and uses the Russian Font data in Control Package File 80 to render the subtitles on the display.

While specific embodiments of this invention have been described, it is to be understood that these embodiments are illustrative and not limiting. Many alternative or additional embodiments in accordance with the broad scope of this invention will be apparent to persons of skill in the art.

### APPENDIX

### <Disc> Element

The <Disc> element is the root element of the Description XML File document tree

### <Disc> Element Syntax

| | |
|---|---|
| Parent | |
| Element | |
| Required | Yes |
| Attributes | xmlns |
| Child | ID |
| Elements | Playlist |
| | Menu |
| Data Type | |
| Data | |
| Restriction | |
| Default | |
| Value | |
| Minimum | 1 |
| Occurrence | |
| Maximum | 1 |
| Occurrence | |
| Example | <Disc xmlns=”http://www.vmedia.net/XML/Video/CL1”> |
| | <ID> |
| | . . . ID elements . . . |
| | </ID> |
| | <Playlist> |
| | . . . Playlist elements . . . |
| | </Playlist> |
| | <Menu> |
| | . . . Menu elements . . . |
| | </Menu> |
| | </Disc> |

<Disc> xmlns Attribute

The xmlns attribute shall always be present and defined with the value: http://www.vmedia.net/XML/Video/CL1

### <ID> Element

The <ID> element describes the general identification of the Disc

### <ID> Element Syntax

| | |
|---|---|
| Parent Element | Disc |
| Required | Yes |
| Attributes | |
| Child Elements | Title |
| | Owner |
| | Copyright |
| | Date |
| Data Type | |
| Data Restriction | |
| Default Value | |
| Minimum | 1 |
| Occurrence | |
| Maximum | 1 |
| Occurrence | |
| Example | <ID> |
| | <Title>. . . title data . . .</Title> |
| | <Owner>. . . owner data . . .</Owner> |
| | <Copyright>. . . copyright data . . .</Copyright> |
| | <Date>. . . date data . . .</Date> |
| | </ID> |

### <Title> Element

Specifies the Title of the content of the disc

### <Title> Element Syntax

| | |
|---|---|
| Parent Element | ID |
| Required | Yes |
| Attributes | |
| Child Elements | |
| Data Type | normalizedString |
| Data Restriction | |
| Default Value | |
| Minimum | 1 |
| Occurrence | |
| Maximum | 1 |
| Occurrence | |
| Example | <ID> |
| | <Title>. . . title data . . .</Title> |
| | <Owner>. . . owner data . . .</Owner> |
| | <Copyright>. . . copyright data . . .</Copyright> |
| | <Date>. . . date data . . .</Date> |
| | </ID> |

### <Owner> Element

Specifies the Owner of the content of the disc

### <Owner> Element Syntax

| | |
|---|---|
| Parent Element | ID |
| Required | No |
| Attributes | |
| Child Elements | |
| Data Type | normalizedString |
| Data Restriction | |
| Default Value | |
| Minimum | 0 |
| Occurrence | |
| Maximum | 1 |
| Occurrence | |
| Example | <ID> |
| | <Title>. . . title data . . .</Title> |
| | <Owner>. . . owner data . . .</Owner> |
| | <Copyright>. . . copyright data . . .</Copyright> |
| | <Date>. . . date data . . .</Date> |
| | </ID> |

### <Copyright> Element

Specifies the Copyright of the content of the disc

### <Copyright> Element Syntax

| | |
|---|---|
| Parent Element | ID |
| Required | No |
| Attributes | |
| Child Elements | |
| Data Type | normalizedString |
| Data Restriction | |
| Defaul Value | |
| Minimum Occurrence | 0 |
| Maximum Occurrence | 1 |
| Example | <ID> |
| | <Title>... title data ...</Title> |
| | <Owner>... owner data ...</Owner> |
| | <Copyright>... copyright data ...</Copyright> |
| | <Date>... date data ...</Date> |
| | </ID> |

### <Date> Element

Specifies the Date of the content of the disc

### <Date> Element Syntax

| | |
|---|---|
| Parent Element | ID |
| Required | No |
| Attributes | |
| Child Elements | |
| Data Type | date |
| Data Restriction | |
| Defaul Value | |
| Minimum Occurrence | 0 |
| Maximum Occurrence | 1 |
| Example | <ID> |
| | <Title>... title data ...</Title> |
| | <Owner>... owner data ...</Owner> |
| | <Copyright>... copyright data ...</Copyright> |
| | <Date>... date data ...</Date> |
| | </ID> |

### <Playlist> Element

The <Playlist> Element specifies Presentations and their specific features

### <Playlist> Element Syntax

| | |
|---|---|
| Parent Element | Disc |
| Required | Yes |
| Attributes | |
| Child Elements | Presentation |
| Data Type | |
| Data Restriction | |
| Defaul Value | |
| Minimum Occurrence | 1 |
| Maximum Occurrence | 1 |
| Example | <Playlist> |
| | <Presentation> |
| | ... Presentation elements ... |
| | </Presentation> |
| | </Playlist> |

### <Presentation> Element

The <Presentation> element contains a description of a Presentation.
a) There must be a minimum of 1<Presentation> element within a <Playlist>.
b) Playback of <Presentation> elements commences from first to last in order unless a <Presentation> is a menu which then controls playback.

### <Presentation> Element Syntax

| | |
|---|---|
| Parent Element | Playlist |
| Required | Yes |
| Attributes | id |
| | src |
| | duration |
| | bypass |
| | onComplete |
| Child Elements | Segment |
| | Subtitle |
| Data Type | |
| Data | |
| Restriction | |
| Defaul Value | |
| Minimum | 1 |
| Occurrence | |
| Maximum | 100 |
| Occurrence | |
| Example | <Presentation id=”Copyright Info” |
| | duration=”00:00:30:00” bypass=”false” |
| | onComplete=”Disc.Playlist.Presentation[‘Menu’].play( )” |
| | > |
| | <Segment/> |
| | </Presentation> |

### <Presentation> id Attribute

The unique identification of the <Presentation>.
a) Must be unique for each <Presentation>.

### <Presentation> id Attribute Syntax

| | |
|---|---|
| Parent Element | Presentation |
| Required | Yes |
| Attributes | |
| Child Elements | |
| Data Type | normalizedString |
| Data Restriction | |
| Defaul Value | |
| Minimum Occurrence | 1 |
| Maximum Occurrence | 1 |
| Example | <Presentation id=”Menu”> |
| | <Segment/> |
| | </Presentation> |

### <Presentation> src Attribute

The fully qualified URI to the file on the Disc which shall be used as the content data source file for this <Presentation>.

### <Presentation> src Attribute Syntax

| | |
|---|---|
| Parent Element | Presentation |
| Required | Yes |
| Attributes | |
| Child Elements | |
| Data Type | anyURI |
| Data Restriction | URI pointing to a Control Package File |
| | or Presentation Package File on the disc |
| Defaul Value | |
| Minimum Occurrence | 1 |
| Maximum Occurrence | 1 |
| Example | <Presentation id=”Movie” |
| | src=”file:///disc/Presentation/file”> |
| | <Segment/> |
| | </Presentation> |

### <Presentation> Duration Attribute

The duration attribute informs the player application of the period of time that the <Presentation> shall play.
a) By default, the player application will playback a <Presentation> until there is no more content data associated with the <Presentation>.
b) The duration attribute, if set, will override the playback of the <Presentation>. If the duration attribute is set to a period of time that is not less than the length of the content, playback will cease when the duration has elapsed. If the duration attribute is set to a period of time equal to or longer than the length of the content, playback will continue with the last content data frame presented until the duration has elapsed.
c) Upon the end of the content data or elapsed duration, if the on Complete attribute is not present, the player application will begin playback of the next <Presentation>.
d) If the on Complete attribute is not present and there are no <Presentation> elements defined after the current <Presentation> element, the first <Presentation> element will begin playback.
e) If the on Complete attribute is not present and there are no additional <Presentation> elements, the player application will start playback of the current <Presentation> from the beginning.
f) The pattern of the value corresponds to hours, minutes and seconds.

### <Presentation> Duration Attribute Syntax

| Parent Element | Presentation | |
|---|---|---|
| Required | No | |
| Attributes | | |
| Child Elements | | |
| Data Type | normalizedString | |
| Data | Pattern | HH:MM:SS |
| Restriction | | Where HH is any number from 00 to 99 |
| | | Where MM is any number from 00 to 59 |
| | | Where SS is any number from 00 to 59 |
| Defaul Value | | |

| | |
|---|---|
| Minimum | 0 |
| Occurrence | |
| Maximum | 1 |
| Occurrence | |
| Example | <Presentation id=”Copyright Info” duration=”00:00:30” |
| | onComplete=”Menu”> |
| | <Segment/> |
| | </Presentation> |

### <Presentation> Bypass Attribute

Defines whether the <Presentation> is able to be bypassed by any User activity other than powering off the player application, shutting down the player application, Stopping disc playback or ejecting the Disc.
a) If false, once the <Presentation> has started it shall play through to finish.
b) If true, at any time during playback of the <Presentation>, User actions shall be, permitted.
c) If unspecified, the player application shall use the Default Value.
d) Regardless of the value of the bypass attribute, a user may pause a <Presentation> at any time.

### <Presentation> Bypass Attribute Syntax

| | |
|---|---|
| Parent Element | Presentation |
| Required | No |
| Attributes | |
| Child Elements | |
| Data Type | boolean |
| Data Restriction | true\|false |
| Defaul Value | true |
| Minimum Occurrence | 0 |
| Maximum Occurrence | 1 |
| Example | <Presentation id=”Copyright Info” bypass=”true” |
| | duration=”00:00:30” onComplete=”Menu”> |
| | <Segment/> |
| | </Presentation> |

<Presentation> onComplete Attribute

The value of <onComplete> is an XML File API Command that shall be performed when the duration attribute timer has elapsed or until there is no more content data associated with the <Presentation>.

<Presentation> onComplete Attribute Syntax

| Parent Element | Presentation | |
|---|---|---|
| Required | No | |
| Attributes | | |
| Child Elements | | |
| Data Type | normalizedString | |
| Data | Minimum String Length | 1 |
| Restriction | Maximum String Length | 2047 |
| | XML File API Command | |
| Defaul Value | | |

| | |
|---|---|
| Minimum | 0 |
| Occurrence | |
| Maximum | 1 |
| Occurrence | |
| Example | <Presentation id=”Copyright Info” duration=”00:00:30” |
| | bypass=”false” |
| | onComplete=”Disc.Playlist.Presentation[‘Menu’].play( )” |
| | > |
| | <Segment/> |
| | </Presentation> |

### <Segment> Element

The <Segment> is used to specify a portion of a <Presentation> which can be used as a starting point of continuous playback or a starting point and ending point of a self contained unit of playback.
a) The <Segment> element is considered the starting point of a chapter.

### <Segment> Element Syntax

| | |
|---|---|
| Parent Element | Presentation |
| Required | No |
| Attributes | id |
| | startTime |
| | endTime |
| Child Elements | |
| Data Type | |
| Data Restriction | |
| Defaul Value | |
| Minimum Occurrence | 0 |
| Maximum Occurrence | 99 |
| Example | <Segment id=”Chapter 3” startTime=”00:22:13” |
| | endTime=”00:36:12”/> |

### <Segment> id Attribute

The unique identification of a <Segment>.

### <Segment> id Attribute Syntax

| | |
|---|---|
| Parent Element | Segment |
| Required | Yes |
| Attributes | |
| Child Elements | |
| Data Type | normalizedString |
| Data Restriction | |
| Defaul Value | |
| Minimum Occurrence | 1 |
| Maximum Occurrence | 1 |
| Example | <Segment id=”Chapter 3” startTime=”00:22:13” |
| | endTime=”00:36:12”/> |

<Segment> startTime Attribute

The startTime attribute of the <Segment> element is used to specify the timecode entry point associated with a <Segment> of a <Presentation>.

a) If startTime is greater than endTime, the Segment will playback with a duration of 00:00:00 if initiated through the playReturn( ) command.

<Segment> startTime Attribute Syntax

| Parent Element | Segment | |
|---|---|---|
| Required | Yes | |
| Attributes | | |
| Child Elements | | |
| Data Type | normalizedString | |
| Data Restriction | Pattern | HH:MM:SS |
| | | Where HH is any number from 00 to 99 |
| | | Where MM is any number from |
| | | 00 to 59 |
| | | Where SS is any number from 00 to 59 |
| Defaul Value | | |

| | |
|---|---|
| Minimum Occurrence | 1 |
| Maximum Occurrence | 1 |
| Example | <Segment id=”Chapter 3” startTime=”00:22:13” |
| | endTime=”00:36:12”/> |

<Segment> endTime Attribute

The endTime attribute of the <Segment> element is used to specify the timecode ending point associated with a <Segment> of a <Presentation>.
a) Playback will not stop at this point unless playback of the Segment was initiated through the playReturn( ) command.
b) If endTime is less than startTime, the Segment will playback with a duration of 00:00:00 if initiated through the playReturn( ) command.
   <Segment> endTime Attribute Syntax

| Parent Element | Segment | |
|---|---|---|
| Required | Yes | |
| Attributes | | |
| Child Elements | | |
| Data Type | normalizedString | |
| Data Restriction | Pattern | HH:MM:SS |
| | | Where HH is any number from 00 to 99 |
| | | Where MM is any number from |
| | | 00 to 59 |
| | | Where SS is any number from 00 to 59 |
| Defaul Value | | |

| | |
|---|---|
| Minimum Occurrence | 1 |
| Maximum Occurrence | 1 |
| Example | <Segment id=”Chapter 3” startTime=”00:22:13” |
| | endTime=”00:36:12”/> |

### <Subtitle> Element

The <Subtitle> element is used to specify information associated with a subtitle track for the Parent Element <Presentation>.
a) For each subtitle track in the Presentation Package File of the Parent Element <Presentation>, a single <Subtitle> Element is required.
b) If a subtitle track in a Presentation Package File is activated but no <Subtitle> element with a corresponding trackNumber exists in the <Presentation>, subtitles will not be active during playback.

### <Subtitle> Element Syntax

| | |
|---|---|
| Parent Element | Presentation |
| Required | No (unless <Presentation> source file uses subtitles) |
| Attributes | trackNumber |
| | forced |
| | default |
| | srcFont |
| Child Elements | |
| Data Type | |
| Data | |
| Restriction | |
| Defaul Value | |
| Minimum | 0 (1 for each subtitle track used in a <Presentation>) |
| Occurrence | |
| Maximum | 20 |
| Occurrence | |
| Example | <Subtitle trackNumber=”3” forced=”true” default=”true” |
| | srcFont=”src=”file:///disc/Control/file#fonts/English. |
| | otf”> |

<Subtitle> trackNumber Attribute

The track number of the subtitle within the Presentation Package File of the Parent Element <Presentation>.

<Subtitle> trackNumber Attribute Syntax

| | |
|---|---|
| Parent Element | Subtitle |
| Required | Yes |
| Attributes | |
| Child Elements | |
| Data Type | nonNegativeInteger |
| Data | Value must be unique for each |
| Restriction | <Subtitle> within a <Presentation> |
| Defaul Value | |
| Minimum | 1 |
| Occurrence | |
| Maximum | 1 |
| Occurrence | |
| Example | <Subtitle trackNumber=”3” forced=”true” default=”true” |
| | srcFont=”src=”file:///disc/Control/file#fonts/English. |
| | otf”> |

### <Subtitle> Forced Attribute

By default a subtitle track within a Presentation Package File is only activated when selected via setTrack( ) from the menu. If a subtitle is intended to be activated automatically and in association with the language of the active audio track, the forced attribute shall be set to true.

### <Subtitle> Forced Attribute Syntax

| | |
|---|---|
| Parent Element | Subtitle |
| Required | No |
| Attributes | |
| Child Elements | |
| Data Type | boolean |
| Data | true\|false |
| Restriction | |
| Defaul Value | false |
| Minimum | 0 |
| Occurrence | |
| Maximum | 1 |
| Occurrence | |
| Example | <Subtitle trackNumber=”3” forced=”true” default=”true” |
| | srcFont=”src=”file:///disc/Control/file#fonts/English. |
| | otf”> |

### <Subtitle> Default Attribute

For <Subtitle> elements with a forced attribute value of true, a default attribute of true specifies that this <Subtitle> element is applied to the default audio track (track 2). If no other audio track is active, the default audio track is active and the <Subtitle> marked as default will apply.
a) If no <Subtitle> elements have default set to true, no forced subtitles will be active for the default audio track.
b) If no <Subtitle> elements have forced set to true, no <Subtitle> elements shall be considered default.
c) If more than one <Subtitle> element has default set to true, the last <Subtitle> element with both default and forced set to true shall be the default.

### <Subtitle> Default Attribute Syntax

| | |
|---|---|
| Parent Element | Subtitle |
| Required | No |
| Attributes | |
| Child Elements | |
| Data Type | boolean |
| Data | true\|false |
| Restriction | |
| Defaul Value | false |
| Minimum | 0 |
| Occurrence | |
| Maximum | 1 |
| Occurrence | |
| Example | <Subtitle trackNumber=”3” forced=”true” default=”true” |
| | srcFont=”src=”file:///disc/Control/file#fonts/English. |
| | otf”> |

<Subtitle> srcFont Attribute

The path to the source font file to be used to render this subtitle track.

<Subtitle> srcFont Attribute Syntax

| | |
|---|---|
| Parent Element | Subtitle |
| Required | Yes |
| Attributes | |
| Child Elements | |
| Data Type | anyURI |
| Data | URI pointing to a font file within a Control Package File |
| Restriction | |
| Defaul Value | |
| Minimum | 1 |
| Occurrence | |
| Maximum | 1 |
| Occurrence | |
| Example | <Subtitle trackNumber=”3” forced=”true” default=”true” |
| | srcFont=”src=”file:///disc/Control/file#fonts/English. |
| | otf”> |

### <Menu> Element

The <Menu> is used to specify menu screens and their specific features associated with the <Presentation> that references the Control Package File.

### <Menu> Element Syntax

| | |
|---|---|
| Parent Element | Disc |
| Required | Yes |
| Attributes | id |
| | default |
| Child Elements | Screen |
| Data Type | |
| Data Restriction | |
| Defaul Value | |
| Minimum Occurrence | 1 |
| Maximum Occurrence | 20 |
| Example | <Menu id=”English”> |
| | <Screen> |
| | ... Screen elements ... |
| | </Screen> |
| | </Menu> |

### <Menu> id Attribute

The id attribute of the <Menu> element is used to uniquely identify a <Menu> within a <Disc>

### <Menu> id Attribute Syntax

| | |
|---|---|
| Parent Element | Menu |
| Required | Yes |
| Attributes | |
| Child Elements | |
| Data Type | normalizedString |
| Data Restriction | |
| Defaul Value | |
| Minimum Occurrence | 1 |
| Maximum Occurrence | 1 |
| Example | <Menu id=”French Menu”> |
| | <Screen> |
| | ... Screen elements ... |
| | </Screen> |
| | </Menu> |

### <Menu> Default Attribute

The default Attribute of the <Menu> is used by the player application to identify the <Menu> that shall be considered the default <Menu>.
a) If no <Menu> has a default Attribute set to true, the first <Menu> defined in the <Disc> shall be considered the default.
b) Only one <Menu> may have the default Attribute set to true.

### <Menu> Default Attribute Syntax

| | |
|---|---|
| Parent Element | Menu |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Menu id=”French Menu” default=”true”> |
| | <Screen> |
| | ... Screen elements ... |
| | </Screen> |
| | </Menu> |

### <Screen> Element

A <Menu> shall contain at least 1 and at most 99<Screen> elements. Each <Screen> contains elements that make up that <Screen> instance. A player application may display 1<Screen> element at any given moment.

### <Screen> Element Syntax

| | |
|---|---|
| Parent Element | Menu |
| Required | Yes |
| Attributes | id |
| | default |
| | duration |
| | loop |
| | bgcolor |
| Child Elements | Large_43 |
| | Large_169 |
| | Small_43 |
| | Small_169 |
| Data Type | |
| Data Restriction | |
| Defaul Value | |
| Minimum Occurrence | 1 |
| Maximum Occurrence | 99 |
| Example | <Screen id=”Main Menu” bgcolor=”#000000”> |
| | <Large_43> |
| | ... Large_43 elements ... |
| | </Large_43> |
| | </Screen> |

### <Screen> id Attribute

The id attribute of the <Screen> element is used to uniquely identify a <Screen> within a <Menu>

### <Screen> id Attribute Syntax

| Parent Element | Screen | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| | Value must be unique for each <Screen> within |
| | a <Menu> |
| Defaul Value | |
| Minimum Occurrence | 1 |
| Maximum Occurrence | 1 |
| Example | <Screen id=”Main Menu” bgcolor=”#000000”> |
| | <Large_43> |
| | ... Large_43 elements ... |
| | </Large_43> |
| | </Screen> |

### <Screen> Default Attribute

The default Attribute of the <Screen> is used by the player application to identify the <Screen> that shall be considered the default <Screen>.
a) If no <Screen> has a default Attribute set to true, the first <Screen> defined in the <Menu> shall be considered the default.
b) Only one <Screen> within a <Menu> may have the default Attribute set to true.

### <Screen> Default Attribute Syntax

| | |
|---|---|
| Parent Element | Screen |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Screen id=”Main Menu” default=”true” |
| | bgcolor=”#000000” duration=”00:00:30” |
| | loop=”true”> |
| | <Large_43> |
| | ... Large_43 elements ... |
| | </Large_43> |
| | </Screen> |

### <Screen> Duration Attribute

The duration Attribute specifies the timecode period of display for the <Screen>.
a) If the loop Attribute is present and set to true, the <Screen> will re-render and restart the timer.
b) If the loop Attribute is not present or set to false, the duration attribute is ignored.
c) If the loop Attribute is true and the duration Attribute value is less than any timer Attribute value for a <Button> child element of a <Graphic> or <Video> child element of this <Screen>, the onTimer attribute of the <Button> child element will never trigger.

### <Screen> Duration Attribute Syntax

| Parent Element | Screen | |
|---|---|---|
| Required | No | |
| Attributes | | |
| Child Elements | | |
| Data Type | normalizedString | |
| Data Restriction | Pattern | HH:MM:SS |
| | | Where HH is any number from 00 to 99 |
| | | Where MM is any number from 00 to 59 |
| | | Where SS is any number from 00 to 59 |

| | |
|---|---|
| Defaul Value | |
| Minimum | 0 |
| Occurrence | |
| Maximum | 1 |
| Occurrence | |
| Example | <Screen id=”Main Menu” bgcolor=”#000000” |
| | duration=”00:00:30” loop=”true”> |
| | <Large_43> |
| | ... Large_43 elements ... |
| | </Large_43> |
| | </Screen> |

### <Screen> Loop Attribute

The loop Attribute specifies whether the <Screen> should re-render at the end of the duration timecode.
a) If the duration Attribute is not present or set to 00:00:00, the loop Attribute is ignored.

### <Screen> Loop Attribute Syntax

| | |
|---|---|
| Parent Element | Screen |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Screen id=”Main Menu” bgcolor=”#000000” |
| | duration=”00:00:30” loop=”true”> |
| | <Large_43> |
| | ... Large_43 elements ... |
| | </Large_43> |
| | </Screen> |

<Screen> bgcolor Attribute

The bgcolor Attribute of a <Screen> defines the background color of the render plane.
a) The background color of the render plane is visible when no <Graphic> or <Video> elements are present in a portion of the render plane or when the <Graphic> present in a portion of the render plane has an alpha channel.
   <Screen> bgcolor Attribute Syntax

| Parent Element | Screen | |
|---|---|---|
| Required | No | |
| Attributes | | |
| Child Elements | | |
| Data Type | string | |
| Data Restriction | Pattern | #?????? |
| | | Where ? is any number from 0 to 9 or |
| | | any letter from A to F. The preceding # |
| | | symbol is optional. The value |
| | | corresponds to the hexadecimal RGB |
| | | color notation, where #000000 is black |
| | | and #FFFFFF is white. |

| | |
|---|---|
| Defaul Value | #000000 |
| Minimum Occurrence | 0 |
| Maximum Occurrence | 1 |
| Example | <Screen id=”Main Menu” bgcolor=”#000000”> |
| | <Large_43> |
| | ... Large_43 elements ... |
| | </Large_43> |
| | </Screen> |

### <Large_{—}43> Element

The <Large_{—}43> element defines the video, graphic, audio and transition objects used for the layout and interactive properties of the parent <Screen> when the player application is displaying the <Screen> on a “large” 4:3 aspect ratio display device.

### <Large_{—}43> Element Syntax

| | |
|---|---|
| Parent Element | Screen |
| Required | No |
| Attributes | |
| Child Elements | Foreground |
| | Background |
| | Transition |
| Data Type | |
| Data Restriction | |
| Defaul Value | |
| Minimum Occurrence | 0 |
| Maximum Occurrence | 1 |
| Example | <Large_43> |
| | <Foreground> |
| | ... Foreground elements ... |
| | </Foreground> |
| | <Background> |
| | ... Background elements ... |
| | </Background> |
| | <Transition/> |
| | </Large_43> |

### <Large_{—}169> Element

The <Large_{—}169> element defines the video, graphic, audio and transition objects used for the layout and interactive properties of the parent <Screen> when the player application is displaying the <Screen> on a “large” 16:9 aspect ratio display device.

### <Large_{—}169> Element Syntax

| | |
|---|---|
| Parent Element | Screen |
| Required | No |
| Attributes | |
| Child Elements | Foreground |
| | Background |
| | Transition |
| Data Type | |
| Data Restriction | |
| Defaul Value | |
| Minimum Occurrence | 0 |
| Maximum Occurrence | 1 |
| Example | <Large_169> |
| | <Foreground> |
| | ... Foreground elements ... |
| | </Foreground> |
| | <Background> |
| | ... Background elements ... |
| | </Background> |
| | <Transition/> |
| | </Large_169> |

### <Small_{—}43> Element

The <Small_{—}43> element defines the video, graphic, audio and transition objects used for the layout and interactive properties of the parent <Screen> when the player application is displaying the <Screen> on a “small” 4:3 aspect ratio display device.

### <Small_{—}43> Element Syntax

| | |
|---|---|
| Parent Element | Screen |
| Required | No |
| Attributes | |
| Child Elements | Foreground |
| | Background |
| | Transition |
| Data Type | |
| Data Restriction | |
| Defaul Value | |
| Minimum Occurrence | 0 |
| Maximum Occurrence | 1 |
| Example | <Small_43> |
| | <Foreground> |
| | ... Foreground elements ... |
| | </Foreground> |
| | <Background> |
| | ... Background elements ... |
| | </Background> |
| | <Transition/> |
| | </Small_43> |

### <Small_{—}169> Element

The <Small_{—}169> element defines the video, graphic, audio and transition objects used for the layout and interactive properties of the parent <Screen> when the player application is displaying the <Screen> on a “small” 16:9 aspect ratio display device.

### <Small_{—}169> Element Syntax

| | |
|---|---|
| Parent Element | Screen |
| Required | No |
| Attributes | |
| Child Elements | Foreground |
| | Background |
| | Transition |
| Data Type | |
| Data Restriction | |
| Defaul Value | |
| Minimum Occurrence | 0 |
| Maximum Occurrence | 1 |
| Example | <Small_169> |
| | <Foreground> |
| | ... Foreground elements ... |
| | </Foreground> |
| | <Background> |
| | ... Background elements ... |
| | </Background> |
| | <Transition/> |
| | </Small_169> |

### <Foreground> Element

The <Foreground> is used to define the layout of <Graphic> and <Video> elements and use of <Audio> elements for the parent <Screen> type (<Large_{—}169>, <Large_{—}43>, <Small_{—}169>,

### <Small_{—}43>).

a) The layout of <Graphic> and <Video> elements in the <Foreground> is rendered “on top” of the <Background>, masking any <Graphic> or <Video> elements in the <Background> layout.

### <Foreground> Element Syntax

| | |
|---|---|
| Parent Element | Large_43, Large_169, Small_43 or Small_169 |
| Required | Yes |
| Attributes | |
| Child Elements | Graphic |
| | Video |
| | Audio |
| Data Type | |
| Data Restriction | |
| Defaul Value | |
| Minimum Occurrence | 1 |
| Maximum Occurrence | 1 |
| Example | <Foreground> |
| | <Graphic> |
| | ... Graphic elements ... |
| | </Graphic> |
| | <Video> |
| | ... Video elements ... |
| | </Video> |
| | <Audio/> |
| | </Foreground> |

### <Graphic> Element

A <Graphic> element is used to define parameters of a graphic object in the <Foreground>.
a)<Graphic> elements for use in <Background> elements are defined later in this Appendix

### <Graphic> Element Syntax

| | |
|---|---|
| Parent Element | Foreground |
| Required | No |
| Attributes | id |
| | src |
| | loop |
| | originX |
| | originY |
| Child Elements | Button |
| Data Type | |
| Data Restriction | |
| Defaul Value | |
| Minimum Occurrence | 0 |
| Maximum Occurrence | 64 |
| Example | <Graphic id=”Title” |
| | src=”file:///disc/Control/file#mainmenu/title.png” |
| | originX=”100” originY=”100”/> |

### <Graphic> id Attribute

The id attribute of the <Graphic> is used to uniquely identify a <Graphic> within a <Foreground>

### <Graphic> id Attribute Syntax

| Parent Element | Graphic | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| | Value must be unique for each <Graphic> within |
| | the <Foreground> |
| Defaul Value | |
| Minimum Occurrence | 1 |
| Maximum Occurrence | 1 |
| Example | <Graphic id=”Title” |
| | src=”file:///disc/Control/file#mainmenu/title.png” |
| | originX=”100” originY=”100”/> |

### <Graphic> src Attribute

The path to the source object for the <Graphic>

### <Graphic> src Attribute Syntax

| | |
|---|---|
| Parent Element | Graphic |
| Required | Yes |
| Attributes | |
| Child Elements | |
| Data Type | anyURI |
| Data Restriction | URI pointing to a graphic file within a |
| | Control Package File |
| Defaul Value | |
| Minimum Occurrence | 1 |
| Maximum Occurrence | 1 |
| Example | <Graphic id=”Title” |
| | src=”file:///disc/Control/file#mainmenu/title.png” |
| | originX=”100” originY=”100”/> |

### <Graphic> Loop Attribute

When the src Attribute of a <Graphic> element has been changed to a video object, this attribute can optionally be used to instruct the player application to repeat the video once the source file has reached the end.
a) If the src Attribute of the <Graphic> is not a video object, this attribute is ignored by a player application.
b) If the loop attribute is not present, the video source file will not loop.

### <Graphic> Loop Attribute Syntax

| | |
|---|---|
| Parent Element | Graphic |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Graphic id=”Title” |
| | src=”file:///disc/Control/file#mainmenu/title.png” |
| | originX=”100” originY=”100” loop=”true”/> |

<Graphic> originX Attribute

Specifies the x-coordinate position (horizontal) of the upper-left most pixel of the <Graphic>
a) For a <Graphic> in <Screen> type <Large_{—}169> the minimum value is 0
b) For a <Graphic> in <Screen> type <Large_{—}43> the minimum value is −96
c) For a <Graphic> in <Screen> type <Small_{—}169> the minimum value is −64
d) For a <Graphic> in <Screen> type <Small_{—}43> the minimum value is −144
e) For a <Graphic> in <Screen> type <Large_{—}169> the maximum value is 767
f) For a <Graphic> in <Screen> type <Large_{—}43> the maximum value is 671
g) For a <Graphic> in <Screen> type <Small_{—}169> the maximum value is 623
h) For a <Graphic> in <Screen> type <Small_{—}43> the maximum value is 703
   <Graphic> originX Attribute Syntax

| Parent Element | Graphic | |
|---|---|---|
| Required | No | |
| Attributes | | |
| Child Elements | | |
| Data Type | integer | |
| Data Restriction | Minimum Value | −144 |
| | Maximum Value | 767 |
| Defaul Value | 0 | |
| Minimum Occurrence | 0 | |
| Maximum Occurrence | 1 | |

| | |
|---|---|
| Example | <Graphic id=”Title” |
| | src=”file:///disc/Control/file#mainmenu/title.png” |
| | originX=”100” originY=”100” originX=”100”/> |

<Graphic> originY Attribute

Specifies the y-coordinate position (vertical) of the upper-left most pixel of the <Graphic>
a) For a <Graphic> in <Screen> type <Large_{—}169> the minimum value is 0
b) For a <Graphic> in <Screen> type <Large_{—}43> the minimum value is 0
c) For a <Graphic> in <Screen> type <Small_{—}169> the minimum value is −36
d) For a <Graphic> in <Screen> type <Small_{—}43> the minimum value is −36
e) For a <Graphic> in <Screen> type <Large_{—}169> the maximum value is 431
f) For a <Graphic> in <Screen> type <Large_{—}43> the maximum value is 431
g) For a <Graphic> in <Screen> type <Small_{—}169> the maximum value is 359
h) For a <Graphic> in <Screen> type <Small_{—}43> the maximum value is 359
   <Graphic> originY Attribute Syntax

| Parent Element | Graphic | |
|---|---|---|
| Required | No | |
| Attributes | | |
| Child Elements | | |
| Data Type | integer | |
| Data Restriction | Minimum Value | −36 |
| | Maximum Value | 431 |
| Defaul Value | 0 | |
| Minimum Occurrence | 0 | |
| Maximum Occurrence | 1 | |

| | |
|---|---|
| Example | <Graphic id=”Title” |
| | src=”file:///disc/Control/file#mainmenu/title.png” |
| | originX=”100” originY=”100” originX=”100” |
| | originY=”100”/> |

### <Video> Element

A <Video> element is used to define parameters of a video object in the <Foreground>.
a) A <Video> element for use in <Background> elements is defined later in this Appendix.
b) Only 1<Video> element is allowed for a given layout type <Large_{—}169>, <Large_{—}43>, <Small_{—}169>, Small_{—}43>. That single <Video> element can be located in either the <Foreground> or the <Background>.

### <Video> Element Syntax

| | |
|---|---|
| Parent Element | Foreground |
| Required | No |
| Attributes | id |
| | src |
| | loop |
| | originX |
| | originY |
| Child Elements | Button |
| Data Type | |
| Data Restriction | |
| Defaul Value | |
| Minimum | 0 |
| Occurrence | |
| Maximum | 1 |
| Occurrence | |
| Example | <Video id=”Spinning Logo” |
| | src=”file:///disc/Control/file#mainmenu/logo.mp4” |
| | originX=”100” originY=”100”/> |

### <Video> id Attribute

The id attribute of the <Video> is used to uniquely identify a <Video> within the <Foreground>

### <Video> id Attribute Syntax

| | | |
|---|---|---|
| Parent Element | Video | |
| Required | Yes | |
| Attributes | | |
| Child Elements | | |
| Data Type | normalizedString | |
| Data Restriction | Minimum String Length | 1 |
| | Maximum String Length | 255 |
| Defaul Value | | |
| Minimum | 1 | |
| Occurrence | | |
| Maximum | 1 | |
| Occurrence | | |

| | |
|---|---|
| Example | <Video id=”Spinning Logo” |
| | src=”file:///disc/Control/file#mainmenu/logo.mp4” |
| | originX=”100” originY=”100”/> |

### <Video> src Attribute

The path to the source object for the <Video>

### <Video> src Attribute Syntax

| | |
|---|---|
| Parent Element | Video |
| Required | Yes |
| Attributes | |
| Child Elements | |
| Data Type | anyURI |
| Data Restriction | URI pointing to a video file within a Control Package |
| | File |
| Defaul Value | |
| Minimum | 1 |
| Occurrence | |
| Maximum | 1 |
| Occurrence | |
| Example | <Video id=”Spinning Logo” |
| | src=”file:///disc/Control/file#mainmenu/logo.mp4” |
| | originX=”100” originY=”100”/> |

### <Video> Loop Attribute

This attribute can optionally be used to instruct the player application to repeat the video once the <Video> source file has reached the end.
a) If the loop attribute is not present, the video source file will not loop.

### <Video> Loop Attribute Syntax

| | |
|---|---|
| Parent Element | Video |
| Required | No |
| Attributes | |
| Child Elements | |
| Data Type | boolean |
| Data Restriction | true\|false |
| Defaul Value | false |
| Minimum | 0 |
| Occurrence | |
| Maximum | 1 |
| Occurrence | |
| Example | <Video id=”Spinning Logo” |
| | src=”file:///disc/Control/file#mainmenu/logo.mp4” |
| | loop=”true” originX=”100” originY=”100”/> |

<Video> originX Attribute

Specifies the x-coordinate position (horizontal) of the upper-left most pixel of the <Video>
a) For a <Video> in <Screen> type <Large_{—}169> the minimum value is 0
b) For a <Video> in <Screen> type <Large_{—}43> the minimum value is −96
c) For a <Video> in <Screen> type <Small_{—}169> the minimum value is −64
d) For a <Video> in <Screen> type <Small_{—}43> the minimum value is −144
e) For a <Video> in <Screen> type <Large_{—}169> the maximum value is 767
f) For a <Video> in <Screen> type <Large_{—}43> the maximum value is 671
g) For a <Video> in <Screen> type <Small_{—}169> the maximum value is 623
h) For a <Video> in <Screen> type <Small_{—}43> the maximum value is 703
   <Video> originX Attribute Syntax

| | | |
|---|---|---|
| Parent Element | Video | |
| Required | No | |
| Attributes | | |
| Child Elements | | |
| Data Type | integer | |
| Data Restriction | Minimum Value | −144 |
| | Maximum Value | 767 |
| Defaul Value | 0 | |
| Minimum | 0 | |
| Occurrence | | |
| Maximum | 1 | |
| Occurrence | | |

| | |
|---|---|
| Example | <Video id=”Spinning Logo” |
| | src=”file:///disc/Control/file#mainmenu/logo.mp4” |
| | loop=”true” originX=”100” originY=”100”/> |

<Video> originY Attribute

Specifies the y-coordinate position (vertical) of the upper-left most pixel of the <Video>.
a) For a <Video> in <Screen> type <Large_{—}169> the minimum value is 0
b) For a <Video> in <Screen> type <Large_{—}43> the minimum value is 0
c) For a <Video> in <Screen> type <Small_{—}169> the minimum value is −36
d) For a <Video> in <Screen> type <Small_{—}43> the minimum value is −36
e) For a <Video> in <Screen> type <Large_{—}169> the maximum value is 431
f) For a <Video> in <Screen> type <Large_{—}43> the maximum value is 431
g) For a <Video> in <Screen> type <Small_{—}169> the maximum value is 359
h) For a <Video> in <Screen> type <Small_{—}43> the maximum value is 359
   <Video> originY Attribute Syntax

| | | |
|---|---|---|
| Parent Element | Video | |
| Required | No | |
| Attributes | | |
| Child Elements | | |
| Data Type | integer | |
| Data Restriction | Minimum Value | −36 |
| | Maximum Value | 431 |
| Defaul Value | 0 | |
| Minimum | 0 | |
| Occurrence | | |
| Maximum | 1 | |
| Occurrence | | |

| | |
|---|---|
| Example | <Video id=”Spinning Logo” |
| | src=”file:///disc/Control/file#mainmenu/logo.mp4” |
| | loop=”true” originX=”100” originY=”100”/> |

### <Audio> Element

<Audio> elements in the <Foreground> are used to define audio content that is triggered by focusAudio attributes of <Button> elements in the same <Foreground>.
a)<Audio> elements in the <Foreground> will only play when triggered by the focusAudio attribute of a <Button> in the same <Foreground>.
b)<Audio> elements play one time to completion.
c) If the maximum allowed number of simultaneous audio streams are already active, the <Audio> element will not trigger.
d)<Audio> elements in the <Background> are described later in this Appendix.

### <Audio> Element Syntax

| | |
|---|---|
| Parent Element | Foreground |
| Required | No |
| Attributes | id |
| | src |
| Child Elements | |
| Data Type | |
| Data Restriction | |
| Defaul Value | |
| Minimum Occurrence | 0 |
| Maximum Occurrence | 255 |
| Example | <Audio id=”Button Focus” |
| | src=”file:///disc/Control/file#mainmenu/ |
| | buttonsound.mp4”/> |

### <Audio> id Attribute

The id attribute of the <Audio> is used to uniquely identify an <Audio> element within a <Foreground>

### <Audio> id Attribute Syntax

| Parent Element | Audio | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| | Value must be unique for each <Audio> within |
| | the <Foreground> |
| Defaul Value | |
| Minimum Occurrence | 1 |
| Maximum Occurrence | 1 |
| Example | <Audio id=”Button Focus” |
| | src=”file:///disc/Control/file#mainmenu/ |
| | buttonsound.mp4”/> |

### <Audio> src Attribute

The path to the source object for the <Audio>

### <Audio> src Attribute Syntax

| | |
|---|---|
| Parent Element | Audio |
| Required | Yes |
| Attributes | |
| Child Elements | |
| Data Type | anyURI |
| Data Restriction | URI pointing to an Audio file within a Control |
| | Package File |
| Defaul Value | |
| Minimum Occurrence | 1 |
| Maximum Occurrence | 1 |
| Example | <Audio id=”Button Focus” |
| | src=”file:///disc/Control/file#mainmenu/ |
| | buttonsound.mp4”/> |

### <Button> Element

The <Button> element is used to define the parameters of a <Graphic> or <Video> element in the <Foreground> that provides interactive functionality to the user.
a)<Button> elements applied to <Graphic> or <Video> elements in the <Background> shall be ignored by a player application.

### <Button> Element Syntax

| | |
|---|---|
| Parent Element | <Graphic> or <Video> elements in |
| | the <Foreground> |
| Required | No |
| Attributes | hasFocus |
| | srcFocus |
| | srcSelected |
| | focusUp |
| | focusDown |
| | focusLeft |
| | focusRight |
| | group |
| | onFocus |
| | onActive |
| | onTimer |
| | timer |
| | focusAudio |
| Child Elements | |
| Data Type | |
| Data Restriction | |
| Defaul Value | |
| Minimum | 0 |
| Occurrence | |
| Maximum | 1 |
| Occurrence | |
| Example | <Graphic id=”Chapter Menu Button” |
| | src=”file:///disc/Control/file#mainmenu/ |
| | chaptermenu.png” originX=”100” |
| | originY=”100”> |
| | <Button hasFocus=”false” |
| | srcFocus=”file:///disc/Control/file#mainmenu/ |
| | chaptermenu-focus.png” focusUp=”Subtitle |
| | Menu Button” focusDown=”Special |
| | Features Button” focusLeft=”Subtitle |
| | Menu Button” focusRight=”Special |
| | Features Button” onFocus=”” |
| | onActive=”Disc.Menu.Screen[‘Chapter |
| | Menu’].show( );” onTimer=”” timer=”00:00:00” |
| | focusAudio=”Button Focus”/> |
| | </Graphic> |

<Button> hasFocus Attribute

This attribute if set to true instructs the player application to set focus on this <Graphic> or <Video> when the menu screen is loaded.
a) The onFocus attribute, if set, should be triggered.
b) The srcFocus attribute, if set, should be used to display the graphic or video.
   <Button> hasFocus Attribute Syntax

| | |
|---|---|
| Parent Element | Button |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” focusUp=”Subtitle Menu |
| | Button” focusDown=”Special Features Button” |
| | focusLeft=”Subtitle Menu Button” |
| | focusRight=”Special Features Button” |
| | onFocus=”” |
| | onActive=”Disc.Menu.Screen[‘Chapter |
| | Menu’].show( );” onTimer=”” timer=”00:00:00” |
| | focusAudio=”Button Focus”/> |

<Button> srcFocus Attribute

The path to the source object for the <Graphic> or <Video> when the object has focus.

<Button> srcFocus Attribute Syntax

| | |
|---|---|
| Parent Element | Button |
| Required | No |
| Attributes | |
| Child Elements | |
| Data Type | anyURI |
| Data Restriction | URI pointing to a Video or Graphic file within a |
| | Control Package File |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” focusUp=”Subtitle |
| | Menu Button” focusDown=”Special |
| | Features Button” focusLeft=”Subtitle |
| | Menu Button” focusRight=”Special |
| | Features Button” onFocus=”” |
| | onActive=”Disc.Menu.Screen[‘Chapter |
| | Menu’].show( );” onTimer=”” timer=”00:00:00” |
| | focusAudio=”Button Focus”/> |

<Button> srcSelected Attribute

The path to the source object for the <Graphic> or <Video> when the object has been selected.
a) If the <Button> does not contain a group attribute, the srcSelected attribute shall be ignored by a player application.
   <Button> srcSelected Attribute Syntax

| | |
|---|---|
| Parent Element | Button |
| Required | No |
| Attributes | |
| Child Elements | |
| Data Type | anyURI |
| Data Restriction | URI pointing to a Video or Graphic file within a |
| | Control Package File |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | englishaudio-focus.png” |
| | srcSelected=”file:///disc/Control/file#mainmenu/ |
| | englishaudio-selected.png” focusUp=”Subtitle |
| | Menu Button” focusDown=”Special |
| | Features Button” focusLeft=”Subtitle |
| | Menu Button” focusRight=”Special |
| | Features Button” group=”Audio Buttons” |
| | onFocus=”” |
| | onActive=”Disc.Playlist.Presentation[‘Main |
| | Video’].setTrack(‘audio’, 2, ‘Subtitle Off’);” |
| | onTimer=”” timer=”00:00:00” |
| | focusAudio=”Button Focus”/> |

<Button> focusUp Attribute

When the current <Button> has focus, this attribute defines which <Button> shall receive focus when Navigation Up has been performed by the User.
a) If this attribute is not defined or empty focus shall not change.
   <Button> focusUp Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 255 |

| | |
|---|---|
| | Value is an XML Schema KEYREF that shall |
| | reference the id attribute of a <Button> within |
| | the same <Foreground> as the <Button> |
| | for which the focusUp attribute has been set. |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special Features |
| | Button” focusLeft=”Subtitle Menu Button” |
| | focusRight=”Special |
| | Features Button” onFocus=”” |
| | onActive=”Disc.Menu.Screen[‘Chapter |
| | Menu’].show( );” |
| | onTimer=”” timer=”00:00:00” |
| | focusAudio=”Button Focus”/> |

<Button> focusDown Attribute

When the current <Button> has focus, this attribute defines which <Button> shall receive focus when Navigation Down has been performed by the User.
a) If this attribute is not defined or empty, focus shall not change.
   <Button> focusDown Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 255 |

| | |
|---|---|
| | Value is an XML Schema KEYREF that shall |
| | reference the id attribute of a <Button> within |
| | the same <Foreground> as the <Button> |
| | for which the focusUp attribute has been set. |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special Features |
| | Button” focusLeft=”Subtitle Menu Button” |
| | focusRight=”Special Features |
| | Button” onFocus=”” |
| | onActive=”Disc.Menu.Screen[‘Chapter |
| | Menu’].show( );” onTimer=”” |
| | timer=”00:00:00” focusAudio=”Button Focus”/> |

<Button> focusLeft Attribute

When the current <Button> has focus, this attribute defines which <Button> shall receive focus when Navigation Left has been performed by the User.
a) If this attribute is not defined or empty, focus shall not change.
   <Button> focusLeft Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 255 |

| | |
|---|---|
| | Value is an XML Schema KEYREF that shall |
| | reference the id attribute of a <Button> within |
| | the same <Foreground> as the <Button> |
| | for which the focusUp attribute has been set. |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special Features |
| | Button” focusLeft=”Subtitle Menu Button” |
| | focusRight=”Special Features |
| | Button” onFocus=”” |
| | onActive=”Disc.Menu.Screen[‘Chapter |
| | Menu’].show( );” onTimer=”” |
| | timer=”00:00:00” focusAudio=”Button Focus”/> |

<Button> focusRight Attribute

When the current <Button> has focus, this attribute defines which <Button> shall receive focus when Navigation Right has been performed by the User.
a) If this attribute is not defined or empty, focus shall not change.
   <Button> focusRight Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 255 |

| | |
|---|---|
| | Value is an XML Schema KEYREF that shall |
| | reference the id attribute of a <Button> within |
| | the same <Foreground> as the <Button> |
| | for which the focusUp attribute has been set. |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special Features |
| | Button” focusLeft=”Subtitle Menu Button” |
| | focusRight=”Special Features Button” |
| | onFocus=”” |
| | onActive=”Disc.Menu.Screen[‘Chapter |
| | Menu’].show( );” onTimer=”” timer=”00:00:00” |
| | focusAudio=”Button Focus”/> |

### <Button> Group Attribute

The group attribute is used to define a group of buttons. Any one <Button> within a group may be selected (using the srcSelected attribute of the <Button>). Selection of a <Button> occurs when a <Button> has focus and the onActive attribute is triggered.
a) When a <Button> onActive attribute is triggered, any <Button> within the same group as this <Button> will change source to the src attribute of the <Graphic> or <Video> Parent Element.
b) Only one <Button> within a group may be selected at any one time.

### <Button> Group Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 255 |

| | |
|---|---|
| | Value is a string shared among <Button> |
| | elements in the <Foreground> that belong to |
| | the same group |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | englishaudio-focus.png” |
| | srcSelected=”file:///disc/Control/file#mainmenu/ |
| | englishaudio-selected.png” focusUp=”Subtitle |
| | Menu Button” focusDown=”Special |
| | Features Button” focusLeft=”Subtitle |
| | Menu Button” focusRight=”Special |
| | Features Button” group=”Audio Buttons” |
| | onFocus=”” |
| | onActive=”Disc.Playlist.Presentation[‘Main |
| | Video’].setTrack(‘audio’, 2, ‘Subtitle Off’);” |
| | onTimer=”” timer=”00:00:00” |
| | focusAudio=”Button Focus”/> |

<Button> onFocus Attribute

This attribute defines the XML API Command to be performed when this <Button> receives Focus

<Button> onFocus Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 2047 |

| | |
|---|---|
| | Value is an XML File API Command |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special Features |
| | Button” focusLeft=”Subtitle Menu |
| | Button” focusRight=”Special Features |
| | Button” onFocus=”Disc.Menu.Screen[‘Sub |
| | Menu’].show( );” |
| | onActive=”Disc.Menu.Screen[‘Chapter |
| | Menu’].show( );” onTimer=”” timer=”00:00:00” |
| | focusAudio=”Button Focus”/> |

<Button> onActive Attribute

This attribute defines the XML File API Command to be performed when this <Button> is activated

<Button> onActive Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 2047 |

| | |
|---|---|
| | Value is an XML File API Command |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special |
| | Features Button” focusLeft=”Subtitle Menu |
| | Button” focusRight=”Special Features |
| | Button” onFocus=”Disc.Menu.Screen[‘Sub |
| | Menu’].show( );” |
| | onActive=”Disc.Menu.Screen[‘Chapter |
| | Menu’].show( );” onTimer=”” timer=”00:00:00” |
| | focusAudio=”Button Focus”/> |

<Button> onTimer Attribute

This attribute defines the XML File API Command to be performed when the timer Attribute of this <Button> has elapsed.
a) If the timer Attribute value is non-existent, or empty, the onTimer command is ignored.
b) If a <Screen> duration elapses before this timer, this timer will never elapse and the onTimer command will never trigger.
c) onTimer does not require the <Button> to have focus to trigger.
   <Button> onTimer Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 2047 |

| | |
|---|---|
| | Value is an XML File API Command |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special |
| | Features Button” focusLeft=”Subtitle Menu |
| | Button” focusRight=”Special Features |
| | Button” onFocus=”Disc.Menu.Screen[‘Sub |
| | Menu’].show( );” |
| | onActive=”Disc.Menu.Screen[‘Chapter |
| | Menu’].show( );” |
| | onTimer=”Disc.Menu.Screen[‘Chapter |
| | Menu’].show( );” |
| | timer=”00:00:00” focusAudio=”Button Focus”/> |

### <Button> Timer Attribute

The timer Attribute specifies the timecode period that must elapse before the onTimer Attribute is triggered.
a) If the onTimer Attribute is non-existent or empty, the timer is ignored.
b) If the <Screen> duration elapses prior to this timer Attribute, this timer Attribute will never elapse and the onTimer Attribute will never trigger.
c) The timer does not require the <Button> have focus to begin or end.
d) A timer value of 00:00:00 will trigger the onTimer command immediately.

### <Button> Timer Attribute Syntax

| Parent Element | Button | |
|---|---|---|
| Required | No | |
| Attributes | | |
| Child Elements | | |
| Data Type | normalizedString | |
| Data | Pattern | HH:MM:SS |
| Restriction | | Where HH is any number from 00 to 99 |
| | | Where MM is any number from 00 to 59 |
| | | Where SS is any number from 00 to 59 |

| | |
|---|---|
| Defaul Value | |
| Minimum | 0 |
| Occurrence | |
| Maximum | 1 |
| Occurrence | |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” focusDown=”Special Features |
| | Button” focusLeft=”Subtitle Menu |
| | Button” focusRight=”Special Features |
| | Button” onFocus=”Disc.Menu.Screen[‘Sub |
| | Menu’].show( );” onActive=”Disc.Menu.Screen[‘Chapter |
| | Menu’].show( );” onTimer=”Disc.Menu.Screen[‘Chapter |
| | Menu’].show( );” timer=”00:05:00” |
| | focusAudio=”Button Focus”/> |

<Button> focusAudio Attribute

When this <Button> receives focus, this attribute defines which <Audio> element of the <Foreground> shall be played.
a) If this attribute refers to a non-existent <Audio> element in the <Foreground>, this attribute is ignored.
   <Button> focusAudio Attribute Syntax

| Parent Element | Button | |
|---|---|---|
| Required | No | |
| Attributes | | |
| Child Elements | | |
| Data Type | normalizedString | |
| Data Restriction | Minimum String Length | 1 |
| | Maximum String Length | 255 |

| | |
|---|---|
| | Value is an XML Schema KEYREF that shall |
| | reference the id attribute of an <Audio> within |
| | the <Foreground> of the same <Screen> type as |
| | as this <Button>. |
| Defaul Value | |
| Minimum Occurrence | 0 |
| Maximum Occurrence | 1 |
| Example | <Button hasFocus=”true” |
| | srcFocus=”file:///disc/Control/file#mainmenu/ |
| | chaptermenu-focus.png” |
| | srcActive=”file:///disc/Control/file#mainmenu/ |
| | chaptermenu-active.png” focusUp=”Subtitle |
| | Menu Button” |
| | focusDown=”Special Features Button” |
| | focusLeft=”Subtitle Menu Button” |
| | focusRight=”Special Features |
| | Button” onFocus=”” |
| | onActive=”Disc.Menu.Screen[‘Chapter |
| | Menu’].show( );” |
| | onTimer=”” timer=”00:00:00” |
| | focusAudio=”Button Focus”/> |

### <Background> Element

The <Background> is used to define the layout of <Graphic> and <Video> elements and playback of <Audio> elements for the parent <Screen> type (<Large_{—}169>, <Large_{—}43>, <Small_{—}169>, <Small_{—}43>)
a) The layout of <Graphic> and <Video> elements in the <Background> is rendered “underneath” of the <Foreground>, where any <Graphic> or <Video> elements in the <Foreground> layout will mask <Graphic> and <Video> elements in the <Background> layout.

### <Background> Element Syntax

| | |
|---|---|
| Parent Element | Large_43, Large_169, Small_43 or Small_169 |
| Required | Yes |
| Attributes | |
| Child Elements | Graphic |
| | Video |
| | Audio |
| Data Type | |
| Data Restriction | |
| Defaul Value | |
| Minimum Occurrence | 1 |
| Maximum Occurrence | 1 |
| Example | <Background> |
| | <Graphic/> |
| | <Video/> |
| | <Audio/> |
| | </Background> |

### <Graphic> Element

A <Graphic> element is used to define parameters of a graphic object in the <Background>.
a)<Graphic> elements in the <Foreground> were previously described in this Appendix.

### <Graphic> Element Syntax

| | |
|---|---|
| Parent Element | Background |
| Required | No |
| Attributes | id |
| | src |
| | loop |
| | originX |
| | originY |
| Child Elements | |
| Data Type | |
| Data Restriction | |
| Defaul Value | |
| Minimum Occurrence | 0 |
| Maximum Occurrence | 64 |
| Example | <Graphic id=”Title” |
| | src=”file:///disc/Control/file#mainmenu/title.png” |
| | originX=”100” originY=”100”/> |

### <Graphic> id Attribute

The id attribute of the <Graphic> is used to uniquely identify a <Graphic> within the <Background>.

### <Graphic> id Attribute Syntax

| Parent Element | Graphic | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| | Value must be unique for each <Graphic> within |
| | the <Background> |
| Defaul Value | |
| Minimum Occurrence | 1 |
| Maximum Occurrence | 1 |
| Example | <Graphic id=”Title” |
| | src=”file:///disc/Control/file#mainmenu/title.png” |
| | originX=”100” originY=”100”/> |

### <Graphic> src Attribute

The path to the source object for the <Graphic>

### <Graphic> src Attribute Syntax

| | |
|---|---|
| Parent Element | Graphic |
| Required | Yes |
| Attributes | |
| Child Elements | |
| Data Type | anyURI |
| Data Restriction | URI pointing to a Graphic file within a Control |
| | Package File |
| Defaul Value | |
| Minimum Occurrence | 1 |
| Maximum Occurrence | 1 |
| Example | <Graphic id=”Title” |
| | src=”file:///disc/Control/file#mainmenu/title.png” |
| | originX=”100” originY=”100”/> |

### <Graphic> Loop Attribute

When the src Attribute of a <Graphic> element has been changed to a video object, this attribute can optionally be used to instruct the player application to repeat the video once the source file has reached the end.
a) If the src Attribute of the <Graphic> is not a video object, this attribute is ignored by a player application.
b) If the loop attribute is not present, the video source file will not loop.

### <Graphic> Loop Attribute Syntax

| | |
|---|---|
| Parent Element | Graphic |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Graphic id=”Title” |
| | src=”file:///disc/Control/file#mainmenu/title.png” |
| | originX=”100” originY=”100” loop=”true”/> |

<Graphic> originX Attribute

Specifies the x-coordinate position (horizontal) of the upper-left most pixel of the <Graphic>
a) For a <Graphic> in <Screen> type <Large_{—}169> the minimum value is 0
b) For a <Graphic> in <Screen> type <Large_{—}43> the minimum value is −96
c) For a <Graphic> in <Screen> type <Small_{—}169> the minimum value is −64
d) For a <Graphic> in <Screen> type <Small_{—}43> the minimum value is −144
e) For a <Graphic> in <Screen> type <Large_{—}169> the maximum value is 767
f) For a <Graphic> in <Screen> type <Large_{—}43> the maximum value is 671
g) For a <Graphic> in <Screen> type <Small_{—}169> the maximum value is 623
h) For a <Graphic> in <Screen> type <Small_{—}43> the maximum value is 703
   <Graphic> originX Attribute Syntax

| Parent Element | Graphic | |
|---|---|---|
| Required | No | |
| Attributes | | |
| Child Elements | | |
| Data Type | integer | |
| Data Restriction | Minimum Value | −144 |
| | Maximum Value | 767 |

| | |
|---|---|
| Defaul Value | 0 |
| Minimum Occurrence | 0 |
| Maximum Occurrence | 1 |
| Example | <Graphic id=”Title” |
| | src=”file:///disc/Control/file#mainmenu/title.png” |
| | originX=”100” originY=”100” originX=”100”/> |

<Graphic> originY Attribute

Specifies the y-coordinate position (vertical) of the upper-left most pixel of the <Graphic>.
a) For a <Graphic> in <Screen> type <Large_{—}169> the minimum value is 0
b) For a <Graphic> in <Screen> type <Large_{—}43> the minimum value is 0
c) For a <Graphic> in <Screen> type <Small_{—}169> the minimum value is −36
d) For a <Graphic> in <Screen> type <Small_{—}43> the minimum value is −36
e) For a <Graphic> in <Screen> type <Large_{—}169> the maximum value is 431
f) For a <Graphic> in <Screen> type <Large_{—}43> the maximum value is 431
g) For a <Graphic> in <Screen> type <Small_{—}169> the maximum value is 359
h) For a <Graphic> in <Screen> type <Small_{—}43> the maximum value is 359
   <Graphic> originY Attribute Syntax

| Parent Element | Graphic | |
|---|---|---|
| Required | No | |
| Attributes | | |
| Child Elements | | |
| Data Type | Integer | |
| Data Restriction | Minimum Value | −36 |
| | Maximum Value | 431 |

| | |
|---|---|
| Defaul Value | 0 |
| Minimum Occurrence | 0 |
| Maximum Occurrence | 1 |
| Example | <Graphic id=”Title” |
| | src=”file:///disc/Control/file#mainmenu/title.png” |
| | originX=”100” originY=”100” originX=”100” |
| | originY=”100”/> |

### <Video> Element

A <Video> element is used to define parameters of a video object in the <Background>.
a) A <Video> element in the <Foreground> was described previously in this Appendix.

### <Video> Element Syntax

| | |
|---|---|
| Parent Element | Background |
| Required | No |
| Attributes | id |
| | src |
| | loop |
| | originX |
| | originY |
| Child Elements | |
| Data Type | |
| Data Restriction | |
| Defaul Value | |
| Minimum Occurrence | 0 |
| Maximum Occurrence | 1 |
| Example | <Video id=”Spinning Logo” |
| | src=”file:///disc/Control/file#mainmenu/ |
| | logo.mp4” |
| | originX=”100” originY=”100”/> |

### <Video> id Attribute

The id attribute of the <Video> is used to uniquely identify a <Video> within a <Background>.

### <Video> id Attribute Syntax

| Parent Element | Video | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| Defaul Value | |
| Minimum Occurrence | 1 |
| Maximum Occurrence | 1 |
| Example | <Video id=”Spinning Logo” |
| | src=”file:///disc/Control/file#mainmenu/ |
| | logo.mp4” |
| | originX=”100” originY=”100”/> |

### <Video> src Attribute

The path to the source object for the <Video>

### <Video> src Attribute Syntax

| | |
|---|---|
| Parent Element | Video |
| Required | Yes |
| Attributes | |
| Child Elements | |
| Data Type | anyURl |
| Data Restriction | URl pointing to a Video file within a Control |
| | Package File |
| Defaul Value | |
| Minimum Occurrence | 1 |
| Maximum Occurrence | 1 |
| Example | <Video id=”Spinning Logo” |
| | src=”file:///disc/Control/file#mainmenu/ |
| | logo.mp4” |
| | originX=”100” originY=”100”/> |

### <Video> Loop Attribute

This attribute can optionally be used to instruct the player application to repeat the video once the <Video> source file has reached the end.
a) If the loop attribute is not present, the video source file will not loop.

### <Video> Loop Attribute Syntax

| | |
|---|---|
| Parent Element | Video |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Video id=”Spinning Logo” |
| | src=”file:///disc/Control/file#mainmenu/ |
| | logo.mp4” |
| | loop=”true” originX=”100” originY=”100”/> |

<Video> originX Attribute

Specifies the x-coordinate position (horizontal) of the upper-left most pixel of the <Video>
a) For a <Video> in <Screen> type <Large_{—}169> the minimum value is 0
b) For a <Video> in <Screen> type <Large_{—}43> the minimum value is −96
c) For a <Video> in <Screen> type <Small_{—}169> the minimum value is −64
d) For a <Video> in <Screen> type <Small_{—}43> the minimum value is −144
e) For a <Video> in <Screen> type <Large_{—}169> the maximum value is 767
f) For a <Video> in <Screen> type <Large_{—}43> the maximum value is 671
g) For a <Video> in <Screen> type <Small_{—}169> the maximum value is 623
h) For a <Video> in <Screen> type <Small_{—}43> the maximum value is 703
   <Video> originX Attribute Syntax

| Parent Element | Video | |
|---|---|---|
| Required | No | |
| Attributes | | |
| Child Elements | | |
| Data Type | integer | |
| Data Restriction | Minimum Value | −144 |
| | Maximum Value | 767 |

| | |
|---|---|
| Defaul Value | 0 |
| Minimum Occurrence | 0 |
| Maximum Occurrence | 1 |
| Example | <Video id=”Spinning Logo” |
| | src=”file:///disc/Control/file#mainmenu/ |
| | logo.mp4” |
| | loop=”true” originX=”100” originY=”100”/> |

<Video> originY Attribute

Specifies the y-coordinate position (vertical) of the upper-left most pixel of the <Video>.
a) For a <Video> in <Screen> type <Large_{—}169> the minimum value is 0
b) For a <Video> in <Screen> type <Large_{—}43> the minimum value is 0
c) For a <Video> in <Screen> type <Small_{—}169> the minimum value is −36
d) For a <Video> in <Screen> type <Small_{—}43> the minimum value is −36
e) For a <Video> in <Screen> type <Large_{—}169> the maximum value is 431
f) For a <Video> in <Screen> type <Large_{—}43> the maximum value is 431
g) For a <Video> in <Screen> type <Small_{—}169> the maximum value is 359
h) For a <Video> in <Screen> type <Small_{—}43> the maximum value is 359
   <Video> originY Attribute Syntax

| Parent Element | Video | |
|---|---|---|
| Required | No | |
| Attributes | | |
| Child Elements | | |
| Data Type | integer | |
| Data Restriction | Minimum Value | −36 |
| | Maximum Value | 431 |

| | |
|---|---|
| Defaul Value | 0 |
| Minimum Occurrence | 0 |
| Maximum Occurrence | 1 |
| Example | <Video id=”Spinning Logo” |
| | src=”file:///disc/Control/file#mainmenu/ |
| | logo.mp4” |
| | loop=”true” originX=”100” originY=”100”/> |

### <Audio> Element

An <Audio> element is used to define playback parameters of an audio object in the <Background>.
a)<Audio> elements in the <Foreground> were described previously in this Appendix.

### <Audio> Element Syntax

| | |
|---|---|
| Parent Element | Background |
| Required | No |
| Attributes | id |
| | src |
| | loop |
| Child Elements | |
| Data Type | |
| Data Restriction | |
| Defaul Value | |
| Minimum Occurrence | 0 |
| Maximum Occurrence | 2 |
| Example | <Audio id=”Button Focus” |
| | src=”file:///disc/Control/file#mainmenu/ |
| | buttonsound.mp 4”/> |

### <Audio> id Attribute

The id attribute of the <Audio> element is used to uniquely identify a <Audio> within a <Background>
a)<Audio> elements defined in the <Background> will automatically play when the <Screen> is loaded.

### <Audio> id Attribute Syntax

| Parent Element | Audio | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| | Value must be unique for each <Audio> within |
| | the <Background> |
| Defaul Value | |
| Minimum Occurrence | 1 |
| Maximum Occurrence | 1 |
| Example | <Audio id=”Button Focus” |
| | src=”file:///disc/Control/file#mainmenu/ |
| | buttonsound.mp4”/> |

### <Audio> src Attribute

The path to the source object for the <Audio>

### <Audio> src Attribute Syntax

| | |
|---|---|
| Parent Element | Audio |
| Required | Yes |
| Attributes | |
| Child Elements | |
| Data Type | anyURI |
| Data Restriction | URI pointing to an Audio file within a Control |
| | Package File |
| Defaul Value | |
| Minimum Occurrence | 1 |
| Maximum Occurrence | 1 |
| Example | <Audio id=”Button Focus” |
| | src=”file:///disc/Control/file#mainmenu/ |
| | buttonsound.mp4”/> |

### <Audio> Loop Attribute

This attribute can optionally be used to instruct the player application to loop playback of the <Audio> source object.

### <Audio> Loop Attribute Syntax

| | |
|---|---|
| Parent Element | Audio |
| Required | No |
| Attributes | |
| Child Elements | |
| Data Type | boolean |
| Data Restriction | true\|false |
| Defaul Value | false |
| Minimum Occurrence | 0 |
| Maximum Occurrence | 1 |
| Example | <Audio id=”Background Music” |
| | src=”file:///disc/Control/file#mainmenu/ |
| | background.mp4” loop=”true”/> |

### <Transition> Element

A <Transition> is used to define a video or graphic stored on the disc that the player application shall display when changing to another <Screen>.
a) The maximum allowed data size of all <Transition> source objects for a single <Screen> type (<Large_{—}169>, <Large_{—}43>, <Small_{—}169>, <Small_{—}43>) is 4 MB.

### <Transition> Element Syntax

| | |
|---|---|
| Parent Element | Large_43, Large_169, Small_43 or Small_169 |
| Required | No |
| Attributes | src |
| | duration |
| | originX |
| | originY |
| | destinationID |
| | destinationType |
| Child Elements | |
| Data Type | |
| Data Restriction | |
| Defaul Value | |
| Minimum Occurrence | 0 |
| Maximum Occurrence | 99 |
| Example | <Transition |
| | src=”file:///disc/Control/file#transitions/ |
| | main_to_chapters.mp4” |
| | destinationID=”Chapter Menu” |
| | destinationType=”Menu”/> |

### <Transition> src Attribute

The path to the source object for the <Transition>

### <Transition> src Attribute Syntax

| | |
|---|---|
| Parent Element | Transition |
| Required | Yes |
| Attributes | |
| Child Elements | |
| Data Type | anyURI |
| Data Restriction | URI pointing to a Video or Graphic file within a |
| | Control Package File |
| Defaul Value | |
| Minimum Occurrence | 1 |
| Maximum Occurrence | 1 |
| Example | <Transition |
| | src=”file:///disc/Control/file#transitions/ |
| | main_to_chapter.mp4” |
| | destinationID=”Chapter Menu” |
| | destinationType=”Menu”/> |

### <Transition> Duration Attribute

The duration Attribute specifies the timecode period that must elapse before the <Transition> source content will be replaced by the destination Attribute menu screen.
a) If the duration Attribute is non-existent or empty, the <Transition> source content will play until it has reached its end. In the case of a Video file, this will be the length of playback time of the data. In the case of a Graphic file, this will be immediately.
b) A duration value of 00:00:00 will end the <Transition> playback immediately.
   <Transition> duration Attribute Syntax

| Parent Element | Transition | |
|---|---|---|
| Required | No | |
| Attributes | | |
| Child Elements | | |
| Data Type | normalizedString | |
| Data Restriction | Pattern | HH:MM:SS |
| | | Where HH is any number from 00 to 99 |
| | | Where MM is any number from |
| | | 00 to 59 |
| | | Where SS is any number from 00 to 59 |

| | |
|---|---|
| Defaul Value | |
| Minimum Occurrence | 0 |
| Maximum Occurrence | 1 |
| Example | <Transition |
| | src=”file:///disc/Control/file#transitions/ |
| | main_to_chapter.mp4” |
| | duration=”00:00:15” destinationID=”Chapter |
| | Menu” destinationType=”Menu”/> |

<Transition> originX Attribute

Specifies the x-coordinate position (horizontal) of the upper-left most pixel of the <Transition>
a) For a <Transition> in <Screen> type <Large_{—}169> the minimum value is 0
b) For a <Transition> in <Screen> type <Large_{—}43> the minimum value is −96
c) For a <Transition> in <Screen> type <Small_{—}169> the minimum value is −64
d) For a <Transition> in <Screen> type <Small_{—}43> the minimum value is −144
e) For a <Transition> in <Screen> type <Large_{—}169> the maximum value is 767
f) For a <Transition> in <Screen> type <Large_{—}43> the maximum value is 671
g) For a <Transition> in <Screen> type <Small_{—}169> the maximum value is 623
h) For a <Transition> in <Screen> type <Small_{—}43> the maximum value is 703
i) Any section of the display frame not covered by the <Transition> src object (or covered by a transparent portion of a Graphic src object) shall display the color assigned to the bgcolor Attribute of the <Screen> that contains the <Transition> element.
   <Transition> originX Attribute Syntax

| Parent Element | Transition | |
|---|---|---|
| Required | No | |
| Attributes | | |
| Child Elements | | |
| Data Type | integer | |
| Data Restriction | Minimum Value | −144 |
| | Maximum Value | 767 |

| | |
|---|---|
| Defaul Value | 0 |
| Minimum Occurrence | 0 |
| Maximum Occurrence | 1 |
| Example | <Transition |
| | src=”file:///disc/Control/file#transitions/ |
| | main_to_chapter.mp4” |
| | duration=”00:00:15” originX=”100” |
| | destinationID=”Chapter Menu” |
| | destinationType=”Menu”/> |

<Transition> originY Attribute

Specifies the y-coordinate position (vertical) of the upper-left most pixel of the <Transition>.
a) For a <Transition> in <Screen> type <Large_{—}169> the minimum value is 0
b) For a <Transition> in <Screen> type <Large_{—}43> the minimum value is 0
c) For a <Transition> in <Screen> type <Small_{—}169> the minimum value is −36
d) For a <Transition> in <Screen> type <Small_{—}43> the minimum value is −36
e) For a <Transition> in <Screen> type <Large_{—}169> the maximum value is 431
f) For a <Transition> in <Screen> type <Large_{—}43> the maximum value is 431
g) For a <Transition> in <Screen> type <Small_{—}169> the maximum value is 359
h) For a <Transition> in <Screen> type <Small_{—}43> the maximum value is 359
i) Any section of the display frame not covered by the <Transition> src object (or covered by a transparent portion of a Graphic src object) shall display the color assigned to the bgcolor Attribute of the <Screen> that contains the <Transition> element.
   <Transition> originY Attribute Syntax

| Parent Element | Transition | |
|---|---|---|
| Required | No | |
| Attributes | | |
| Child Elements | | |
| Data Type | integer | |
| Data Restriction | Minimum Value | −36 |
| | Maximum Value | 431 |

| | |
|---|---|
| Defaul Value | 0 |
| Minimum Occurrence | 0 |
| Maximum Occurrence | 1 |
| Example | <Transition |
| | src=”file:///disc/Control/file#transitions/ |
| | main_to_chapter.mp4” |
| | duration=”00:00:15” originX=”100” |
| | originY=”100” destinationID=”Chapter Menu” |
| | destinationType=”Menu”/> |

<Transition> destinationID Attribute

The id of the destination <Presentation>, <Menu> or <Screen> of the <Transition>.

<Transition> destinationID Attribute Syntax

| Parent Element | Transition | |
|---|---|---|
| Required | Yes | |
| Attributes | | |
| Child Elements | | |
| Data Type | normalizedString | |
| Data Restriction | Minimum String Length | 1 |
| | Maximum String Length | 255 |

| | |
|---|---|
| | Value must correspond to the id attribute of a |
| | <Screen> in the current <Menu>, |
| | the id attribute of a <Menu> in the |
| | <Disc> or the id attribute of a |
| | <Presentation> in the <Disc> |
| Defaul Value | |
| Minimum Occurrence | 1 |
| Maximum Occurrence | 1 |
| Example | <Transition |
| | src=”file:///disc/Control/file#transitions/ |
| | main_to_chapter.mp4” |
| | destinationID=”Chapter Menu” |
| | destinationType=”Menu”/> |

<Transition> destinationType Attribute

The type of XML structure of the destination. The <Transition> destinationID attribute value must correspond to the id attribute value of an element of destinationType.
a) For destinationType of “Presentation”, the <Transition> destinationID attribute value must correspond to a <Presentation> id attribute value within the <Disc>
b) For destinationType of “Menu”, the <Transition> destinationID attribute value must correspond to a <Menu> id attribute value within the <Disc>
c) For destinationType of “Screen”, the <Transition> destinationID attribute value must correspond to a <Screen> id attribute value within the current <Menu>
   <Transition> destinationType Attribute Syntax

| Parent Element | Transition | |
|---|---|---|
| Required | Yes | |
| Attributes | | |
| Child Elements | | |
| Data Type | normalizedString | |
| Data Restriction | Minimum String Length | 4 |
| | Maximum String Length | 12 |

| | |
|---|---|
| | Value must be one of: |
| | Presentation |
| | Menu |
| | Screen |
| Defaul Value | |
| Minimum Occurrence | 1 |
| Maximum Occurrence | 1 |
| Example | <Transition |
| | src=”file:///disc/Control/file#transitions/ |
| | main_to_chapter.mp4” |
| | destinationID=”Chapter Menu” |
| | destinationType=”Menu”/> |

We claim:

1. An optical data storage disc comprising:
a description file, the description file being written in Extensible Markup Language (XML), the description file containing a general information section, a playlist information section and a menu information section; and
a plurality of playback items, the playback items comprising at least one presentation package file and a one control package file, wherein
the general information section contains information descriptive of the content of a presentation package file;
the playlist information section contains data referencing individual ones of the playback items;
the at least one presentation package file contains interleaved audio and video data;
the one control package file contains a plurality of objects; and
the menu information section contains a plurality of graphic layout screens, each of the graphic layout screens referencing a preselected group of objects in a control package file, the preselected group of objects being selected so as to composite a graphical interface when displayed on a video display, the graphical interface enabling a user to access either another graphic layout screen or the content of a presentation package file.

2. The optical data storage disc of claim 1 wherein the at least one presentation package file contains subtitle data interleaved with the audio and video data.

3. The optical data storage disc of claim 1 wherein the audio data comprises at least two different types of audio data.

4. The optical data storage disc of claim 3 wherein at least one of the graphic layout screens presents a user with an option to choose one of the types of audio data.

5. The optical data storage disc of claim 1 wherein the objects in the one control package file comprise at least one of audio, video and graphic objects.

6. The optical data storage disc of claim 1 wherein the graphic layout screens are subdivided into a plurality of groups adapted, respectively, for video displays of different aspect ratios.

7. The optical data storage disc of claim 1 wherein the graphic layout screens are subdivided into a plurality of groups adapted, respectively, for video displays of different sizes.

8. The optical data storage disc of claim 1 wherein the graphic layout screens comprise a first group adapted for small displays having a 4:3 aspect ratio, a second group adapted for small displays having a 16:9 aspect ratio, a third group adapted for large displays having a 4:3 aspect ratio and a fourth group adapted for large displays having a 16:9 aspect ratio.

9. The optical data storage disc of claim 1 wherein the description file comprises a uniform resource identifier (URI), the URI exclusively referencing data contained in a control package file.

10. The optical data storage disc of claim 9 wherein the syntax and the identification syntax of the URI are defined in section 8.44.7 of the ISO 14496:2005 ISO Base Media File Format specification.

11. A method of reading data stored on an optical disc, the optical disc containing at least one presentation, the method comprising:
using a menu displayed on a video display to generate a play command, the play command causing a presentation to be read continuously from a specified timecode position either until the timecode position reaches a duration value for the presentation or until the end of the available source content for the presentation is reached, and then
continuing on to the next available presentation.

12. The method of claim 11 wherein the at least one presentation includes a presentation divided into a plurality of segments and wherein the play command causes the presentation to be read continuously from a start timecode value of the segment either until the timecode position reaches a duration timecode value for the presentation or until the end of the available source content for the presentation is reached.

13. A method of reading data stored on an optical disc, the optical disc containing at least one presentation, the method comprising:
using a screen displayed on a video display to activate a menu;
using the menu to generate a playReturn command, the playReturn command causing a presentation to be read continuously from a specified timecode position either until the timecode position reaches a duration value for the presentation or until the end of the available source content for the presentation is reached, and then
returning to the screen.

14. The method of claim 13 wherein the at least one presentation includes a presentation divided into a plurality of segments and wherein the playReturn command causes the presentation to be read continuously from a start timecode value of the segment to an endtime code from the segment.

15. A method of reading data stored on an optical disc, the optical disc containing at least one presentation, the method comprising using only the following commands:
a play command, a menu displayed on a video display being used to generate the play command, the play command causing a presentation to be read continuously from a specified timecode position either until the timecode position reaches a duration value for the presentation or until the end of the available source content for the presentation is reached and then continuing on to the next available presentation;
a playReturn command, a menu displayed on a video display being used to generate the playReturn command, the menu being activated by a screen, the playReturn command causing a presentation to be read continuously from a specified timecode position either until the timecode position reaches a duration value for the presentation or until the end of the available source content for the presentation is reached and then returning to the screen;
a show command, the show command causing an specified menu to be shown on the display; and
a setTrack command, the setTrack command specifying an audio or subtitle track that is the active track within a presentation.

16. A method of recording video data on an optical disc, the video data being initially represented in the form of a source frame and being recorded on the optical disc in the form of an encoded frame, each of the source and encoded frames having a width and a height measured in pixels, the method comprising:
scaling the data in the source frame such that the data occupies the entire height of the encoded frame, and
scaling the data in the source frame such that the data occupies the entire width of the encoded frame.

17. The method of claim 16 comprising reading the video data to a video display, the video data on the display having an aspect ratio equal to an aspect ratio of the source frame.

18. An optical data storage disc comprising audio, video and subtitle data, the subtitle data being stored as a plurality of text data.

19. The optical data storage disc of claim 19 wherein the audio, video and subtitle data are interleaved on the disc.

20. A method of playing audio, video and subtitle data stored on an optical data storage disc on a video display, the subtitle data being stored as a plurality of text data, the optical data storage disc further comprising a format file, the method comprising:
reading the text data;
reading the format file; and
using the text data and the format file to composite a portion of a subtitle to be shown on the display.
